(19) United States
(12) Patent Application Publication
(10) Pub. No.: US 2012/0316080 A1
(43) Pub. Date: Dec. 13, 2012

(54) DIFFERENTIATION BETWEEN BRCA2-ASSOCIATED TUMOURS AND SPORADIC TUMOURS VIA ARRAY COMPARATIVE GENOMIC HYBRIDIZATION

(75) Inventors: Petra Marleen Nederlof, Amsterdam (NL); Sabine Charlotte Linn, Amsterdam (NL)

(73) Assignee: Stichting Het Nederlands Kanker Instiuut

(21) Appl. No.: 13/502,717

(22) PCT Filed: Oct. 19, 2010
(86) PCT No.: PCT/IB2010/002892

§ 371 Date: Jun. 29, 2012

Related U.S. Application Data
(60) Provisional application No. 61/279,584, filed on Oct. 19, 2009.

(51) Int. Cl. C40B 30/04; C40B 40/06

(52) U.S. Cl. 506/9; 506/16

(57) ABSTRACT

Array comparative genomic hybridization classifiers, arrays comprising the classifiers and methods of using the same for differentiating between BRCA2-associated tumors and sporadic tumors by detecting phenotypic genetic traits using comparative genomic hybridization are disclosed.

### CROSS REFERENCE TO RELATED APPLICATIONS

This Patent Cooperation Treaty (PCT) patent application claims priority to U.S. provisional patent application No. 61/279,584, filed Oct. 19, 2009, entitled “Methods for Differentiation Between BRCA2-Associated Tumours and Sporadic Tumours” the contents of which are incorporated herein by reference, in their entirety.

### FIELD

Array comparative genomic hybridization classifiers, arrays comprising the classifiers, and related methods provided by the present disclosure may be used to differentiate between BRCA2-associated tumours and sporadic tumors.

### BACKGROUND

Breast cancer is the most common cancer in the developed countries and one of the leading causes of death in women; one out of every nine women will be affected by breast cancer. Approximately 10-15% of patients with breast cancer have a positive family history for breast cancer, and of those, approximately 25-50% is due to a mutation in the gene or genes that code for the breast cancer predisposition genes BRCA1 and/or BRCA2 (see Narod and Foulkes, 2004, Nat. Rev. Cancer. 4(9):665-76).

BRCA2 (Breast Cancer Type 2 susceptibility protein) is a protein encoded by the BRCA2 gene. The BRCA2 gene is located on the long (q) arm of chromosome 13 at position 12.3 (13q12.3), from base pair 31,787,616 to base pair 31,871,804 (see Wooster et al., 1994, Science 265(5181): 2088-90).

BRCA2 belongs to the tumor suppressor gene family and is thought to be involved in the repair of chromosomal damage, specifically the repair of breaks in double-stranded DNA. BRCA2 thus helps maintain the stability of the human genome and helps prevent gene mutations and rearrangements that can lead to cancers.

Mutations of the BRCA2 gene can cause the BRCA2 protein to be abnormal and defective. Defective BRCA2 protein is unable to function normally and thus cannot repair breaks in DNA. As a result, mutations build up that can cause uncontrolled cell growth, leading to cancers.

In addition to breast cancer in men and women, mutations in the BRCA2 gene can lead to an increased risk of ovarian, fallopian, prostate, and pancreatic cancers, as well as malignant melanoma. Several other types of cancer have also been seen in certain families carrying BRCA2 gene mutations.

Identification of a mutation in the BRCA2 gene in a patient can assist a health care provider in determining the proper course of treatment for the patient. Additionally, mutation identification allows for pre-symptomatic mutation screening in family members.

The current strategy to identify BRCA2 gene mutation carriers is to select eligible patients based on prediction models that use age and family history. Mutation screening is then performed. However, it is not clear to what extent BRCA2 mutation carriers are properly identified, as the cause of breast cancer in many families with a history of breast cancer remain unexplained. Prediction models are imperfect and are dependent on the number of family members from which information is available. Mutation screening may identify unclassified variants (UV) in the BRCA2 gene for which the pathogenicity is unknown, as the effect on BRCA2 protein function is unknown. Although functional assays for BRCA2 mutations exist, they are laborious, difficult to interpret in clinical terms, limited to only a number of protein functions, and thus not yet applicable in a diagnostic setting.

For BRCA1-mutated tumors, several molecular portraits have been generated using copy number alterations and gene expression patterns, which can be used to successfully identify BRCA1-associated tumours. For BRCA2-mutated tumors, however, no specific genetic signature has been identified and the immunohistochemical phenotype is poorly defined. Although previous studies have investigated differences between BRCA1-mutated, BRCA2-mutated and sporadic breast tumors in gene expression patterns and copy number alterations, these molecular portraits have not been clinically validated or evaluated.

### SUMMARY

Thus, a validated BRCA2 genetic signature, independent of tumor grade and receptor status, is useful.

It is an object of the present disclosure to provide for a method and means for prognostic and/or diagnostic genomic profiling of tumours for BRCA2 involvement. Therefore, one goal of the present disclosure is to evaluate profiling of somatic genetic changes in breast tumors as a new strategy that can give additional information about the involvement of BRCA2 in tumorigenesis.

In a first aspect, methods for using a BRCA2 aCGH classifier to detect genomic copy number variations in a test sample, as compared to a reference sample, in one, or in some embodiments a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28 are disclosed. The methods comprise detecting genomic copy number variations in a test sample, wherein the copy number variations are detected in at least one, or in some embodiments a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23p26.2-28, and wherein a variation in copy number at any one or more of the genomic loci, as compared to the number of copies of DNA from a reference sample, classifies the cell sample as from either a BRCA2-associated tumor or a sporadic tumor. In some embodiments, the genomic copy number variations are detected at all 25 genomic loci. In some embodiments, the genomic copy number variations are detected at a number of genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, the genomic copy number variations are detected at a number of genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2.

In a second aspect, methods for using a BRCA2 aCGH classifier to detect genomic copy number variations in a test sample, as compared to a reference sample, in one, or in some embodiments a plurality, of the genomic loci selected from 4p13-12, 13q12.2-21.1, 13q31.3-33.1, 14q23.2-32.33, 16q12.1-21, 17q11.1-12 and 17q21.2-21.31 are disclosed. The methods comprise detecting genomic copy number variations in a test sample, wherein the copy number variations are detected in one, or in some embodiments a plurality, of the genomic loci selected from 4p13-12, 13q12.2-21.1, 13q31.3-33.1, 14q23.2-32.33, 16q12.1-21, 17q11.1-12 and 17q21.2-21.31, and wherein a variation in copy number at any one or more of the genomic loci, as compared to the number of copies of DNA from a reference sample, classifies the cell sample as from either a BRCA2-associated tumor or a sporadic tumor. In some embodiments, the genomic copy number variations are detected at all 7 genomic loci. In some embodiments, the genomic copy number variations are detected at a number of genomic loci selected from greater than 1, greater than 2, greater than 3, greater than 4, greater than 5, and greater than 6. In some embodiments, the genomic copy number variations are detected at a number of genomic loci selected from less than 7, less than 6, less than 5, less than 4, less than 3, and less than 2.

In a third aspect, methods for using a BRCA2 aCGH classifier to detect genomic copy number variations in a test sample, as compared to a reference sample, are disclosed, wherein the classifier comprises at least one, or in some embodiments a plurality, of the BAC clones set forth in FIG. 2. The methods comprise detecting genomic copy number variations in a test sample, wherein the copy number variations are detected using at least one, or in some embodiments a plurality, of the BAC clones of FIG. 2, and wherein a variation in copy number at any one or more of the BAC clones, as compared to the number of copies of DNA from a reference sample, classifies the cell sample as from either a BRCA2-associated tumor or a sporadic tumor. In some embodiments, the genomic copy number variations are detected using all 704 of the BAC clones set forth in FIG. 2. In some embodiments, the genomic copy number variations are detected using a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, the genomic copy number variations are detected using a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

In a fourth aspect, methods for using a BRCA2 aCGH classifier to detect genomic copy number variations in a test sample, as compared to a reference sample, in one, or in some embodiments a plurality, of the genomic loci selected from 6p25.3-11.1, 6q12-13 and 13q31.3-33.1 are disclosed. The methods comprise detecting genomic copy number variations in a test sample, wherein the copy number variations are detected in at least one, or in some embodiments a plurality, of the genomic loci selected from 6p25.3-11.1, 6q12-13 and 13q31.3-33.1, and wherein an increase in copy number at any one or more of the genomic loci, as compared to the number of copies of DNA from a reference sample, classifies the cell sample as from a BRCA2-associated tumor. In some embodiments, the genomic copy number variations are detected at all 3 genomic loci. In some embodiments, the genomic copy number variations are detected at a number of genomic loci selected from greater than 1 and greater than 2. In some embodiments, the genomic copy number variations are detected at a number of genomic loci selected from less than 3, and less than 2.

In a fifth aspect, methods for using a BRCA2 aCGH classifier to detect genomic copy number variations in a test sample, as compared to a reference sample, in one, or in some embodiments a plurality, of genomic loci selected from 10q22.3-26.13, 13q12.2-21.1 and 14q23.2-32.33 are disclosed. The methods comprise detecting genomic copy number variations in a test sample, wherein the copy number variations are detected in at least one, or in some embodiments a plurality, of the genomic loci selected from 10q22.3-26.13, 13q12.2-21.1 and 14q23.2-32.33, and wherein a decrease in copy number at any one or more of the genomic loci, as compared to the number of copies of DNA from a reference sample, classifies the cell sample as from a BRCA2-associated tumor. In some embodiments, the genomic copy number variations are detected at all 3 genomic loci. In some embodiments, the genomic copy number variations are detected at a number of genomic loci selected from greater than 1 and greater than 2. In some embodiments, the genomic copy number variations are detected at a number of genomic loci selected from less than 3, and less than 2.

In a sixth aspect, methods for using a BRCA2 aCGH classifier to detect genomic copy number variations in a test sample, as compared to a reference sample, in the genomic locus 16p12.3-11.2 are disclosed. The methods comprise detecting genomic copy number variations in a test sample, wherein the copy number variations are detected at the genomic locus 16p12.3-11.2, and wherein an increase in copy number at 16p12.3-11.2, as compared to the number of copies of DNA from a reference sample, classifies the cell sample as from a sporadic tumor.

In a seventh aspect, methods for using a BRCA2 aCGH classifier to detect genomic copy number variations in a test sample, as compared to a reference sample, in one, or in some embodiments a plurality, of the genomic loci selected from 2q36.3-37.1, 4p13-12, 16q12.1-21, 17q11.1-12 and 17q21.2-21.31 are disclosed. The methods comprise detecting genomic copy number variations in a test sample, wherein the copy number variations are detected in at least one, or in some embodiments a plurality, of the genomic loci selected from 2q36.3-37.1, 4p13-12, 16q12.1-21, 17q11.1-12 and 17q21.2-21.31, and wherein a decrease in copy number at any one or more of the genomic loci, as compared to the number of copies of DNA from a reference sample, classifies the cell sample as from a sporadic tumor. In some embodiments, the genomic copy number variations are detected at all 5 genomic loci. In some embodiments, the genomic copy number variations are detected at a number of genomic loci selected from greater than 1, greater than 2, greater than 3, and greater than 4. In some embodiments, the genomic copy number variations are detected at a number of genomic loci selected from less than 5, less than 4, less than 3, and less than 2.

### BRIEF DESCRIPTION OF THE DRAWINGS

Those skilled in the art will understand that the drawings, described herein, are for illustration purposes only. The drawings are not intended to limit the scope of the present disclosure.

FIG. 1A depicts the BRCA2-associated genomic loci used to identify breast cancers with a BRCA2-deficient homologous recombination dependent DNA repair system.

FIG. 1B depicts a subset of the BRCA2-associated genomic loci of FIG. 1A.

FIG. 2 depicts exemplary BAC clones that may be used to detect, or to generate probes to detect, copy number aberrations in the genomic loci of FIGS. 1A and 1B.

### DETAILED DESCRIPTION

### Definitions

“Array” refers to an arrangement, on a substrate surface, of multiple nucleic acid probes (as defined herein) of predetermined identity. In various embodiments, the sequences of each of the multiple nucleic acid probes are known. In general, an array comprises a plurality of target elements, each target element comprising one or more nucleic acid probes immobilized on one or more solid surfaces, to which sample nucleic acids can be hybridized. In various embodiments, each individual probe is immobilized to a designated, discrete location (i.e., a defined location or assigned position) on the substrate surface. In various embodiments, each nucleic acid probe is immobilized to a discrete location on an array and each has a sequence that is either specific to, or characteristic of, a particular genomic locus. A nucleic acid probe is specific to, or characteristic of, a genomic locus when it contains a nucleic acid sequence that is unique to that genomic locus. Such a probe preferentially hybridizes to a nucleic acid made from that genomic locus, relative to nucleic acids made from other genomic loci.

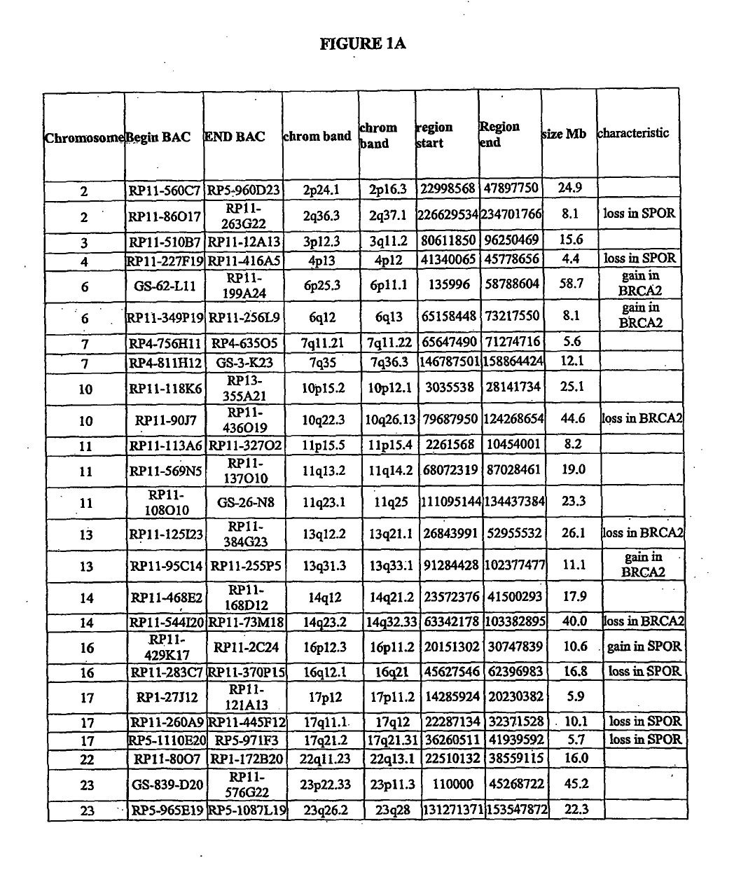

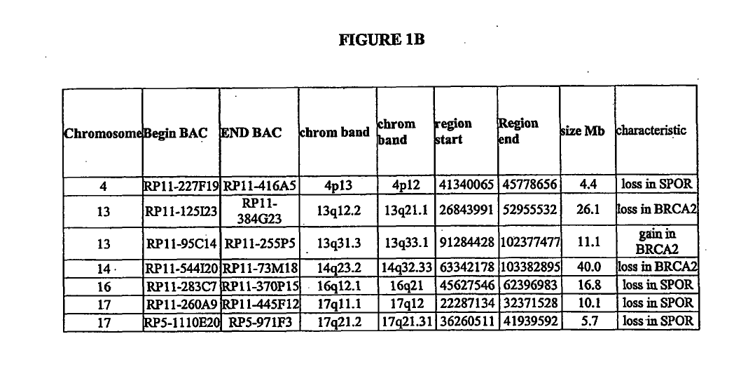

The nucleic acid probes can contain sequence(s) from specific genes or clones. In various embodiments, at least some of the nucleic acid probes contain sequences from any one or more of the specific genomic regions recited in FIG. 1A. In various embodiments, at least some of the nucleic acid probes contain sequences from any one or more of the specific genomic regions recited in FIG. 1B. In various embodiments, at least some of the nucleic acid probes contain sequences of known, reference genes or clones. In various embodiments, the nucleic acid probes in a single array contain both sequences from any one or more of the specific genomic regions recited in FIG. 1A and sequences of known, reference genes or clones. In various embodiments, the nucleic acid probes in a single array contain both sequences from any one or more of the specific genomic regions recited in FIG. 1B and sequences of known, reference genes or clones.

The probes may be arranged on the substrate in a single density, or in varying densities. The density of each of the probes can be varied to accommodate certain factors such as, for example, the nature of the test sample, the nature of a label used during hybridization, the type of substrate used, and the like. Each probe may comprise a mixture of nucleic acids of varying lengths and, thus, varying sequences. For example, a single probe may contain more than one copy of a cloned nucleic acid, and each copy may be broken into fragments of different lengths. Each length will thus have a different sequence.

The length, sequence and complexity of the nucleic acid probes may be varied. In various embodiments, the length, sequence and complexity are varied to provide optimum hybridization and signal production for a given hybridization procedure, and to provide the required resolution among different genes or genomic locations.

“BRCA2-associated tumor” means a tumor having cells containing a mutation of the BRCA2 locus or a deficiency in the homologous recombination-dependent double strand break DNA repair pathway that alters BRCA2 activity or function, either directly or indirectly.

“CGH” or “Comparative Genomic Hybridization” refers generally to molecular-cytogenetic techniques for the analysis of copy number changes, gains and/or losses, in the DNA content of a given subject's DNA. CGH can be used to identify chromosomal alterations, such as unbalanced chromosomal changes, in any number of cells including, for example, cancer cells. In various embodiments, CGH is utilized to detect one or more chromosomal amplifications and/or deletions of regions between a test sample and a reference sample.

“Chromosomal locus” refers to a specific, defined portion of a chromosome.

“Genome” refers to all nucleic acid sequences, coding and non-coding, present in each cell type of a subject. The term also includes all naturally occurring or induced variation of these sequences that may be present in a mutant or disease variant of any cell type, including, for example, tumor cells. Genomic DNA and genomic nucleic acids are thus nucleic acids isolated from a nucleus of one or more cells, and include nucleic acids derived from, isolated from, amplified from, or cloned from genomic DNA, as well as synthetic versions of all or any part of a genome.

For example, the human genome consists of approximately 3.0×10⁹ base pairs of DNA organized into 46 distinct chromosomes. The genome of a normal human diploid somatic cell consists of 22 pairs of autosomes (chromosomes 1 to 22) and either chromosomes X and Y (male) or a pair of X chromosomes (female) for a total of 46 chromosomes. A genome of a cancer cell may contain variable numbers of each chromosome in addition to deletions, rearrangements and amplification of any sub-chromosomal region or DNA sequence.

“Genomic locus” refers to a specific, defined portion of a genome.

“HBOC tumors” refers to tumors from patients from Hereditary Breast and Ovarian Cancer families, who display a negative screen result for BRCA1 and/or BRCA2 mutation. Such patients have a family history that include at least two diagnoses for breast cancer and one diagnosis for ovarian cancer.

“Hybridization” refers to the binding of two single stranded nucleic acids via complementary base pairing. Extensive guides to the hybridization of nucleic acids can be found in: Tijssen, Laboratory Techniques in Biochemistry and Molecular Biology-Hybridization with Nucleic Acid Probes Part I, Ch. 2, “Overview of principles of hybridization and the strategy of nucleic acid probe assays” (1993), Elsevier, N.Y.; and Sambrook et al., Molecular Cloning: A Laboratory Manual (3rd ed.) Vol. 1-3 (2001), Cold Spring Harbor Laboratory, Cold Spring Harbor Press, N.Y. The phrases “hybridizing specifically to”, “specific hybridization”, and “selectively hybridize to”, refer to the preferential binding, duplexing, or hybridizing of a nucleic acid molecule to a particular probe under stringent conditions. The term “stringent conditions” refers to hybridization conditions under which a probe will hybridize preferentially to its target subsequence, and to a lesser extent, or not at all, to other sequences in a mixed population (e.g., a DNA preparation from a tissue biopsy). “Stringent hybridization” and “stringent hybridization wash conditions” are sequence-dependent and are different under different environmental parameters.

Generally, highly stringent hybridization and wash conditions are selected to be about 5° C. lower than the thermal melting point (Tm) for a specific sequence at a defined ionic strength and pH. The Tm is the temperature at which 50% of the target sequence hybridizes to a perfectly matched probe. Very stringent conditions are selected to be equal to the Tm for a particular probe. Often, a high stringency wash is preceded by a low stringency wash to remove background probe signal. An example of stringent hybridization conditions for hybridization of complementary nucleic acids which have more than 100 complementary residues on an array is 42° C. using standard hybridization solutions, with the hybridization being carried out overnight. An example of highly stringent wash conditions is a 0.15 M NaCl wash at 72° C. for 15 minutes. An example of stringent wash conditions is a wash in 0.2× Standard Saline Citrate (SSC) buffer at 65° C. for 15 minutes. An example of a medium stringency wash for a duplex of, for example, more than 100 nucleotides, is 1×SSC at 45° C. for 15 minutes. An example of a low stringency wash for a duplex of, for example, more than 100 nucleotides, is 4× to 6×SSC at 40° C. for 15 minutes.

“Micro-array” refers to an array that is miniaturized so as to require microscopic examination for visual evaluation. In various embodiments, the arrays used in the methods of the present disclosure are micro-arrays.

“Nucleic acid” refers to a deoxyribonucleotide or ribonucleotide in either single- or double-stranded form and includes all nucleic acids comprising naturally occurring nucleotide bases as well as nucleic acids containing any and/or all analogues of natural nucleotides. This term also includes nucleic acid analogues that are metabolized in a manner similar to naturally occurring nucleotides, but at rates that are improved for the purposes desired. This term also encompasses nucleic-acid-like structures with synthetic backbone analogues including, without limitation, phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs) (see, e.g.: “Oligonucleotides and Analogues, a Practical Approach,” edited by F. Eckstein, IRL Press at Oxford University Press (1991); “Antisense Strategies,” Annals of the New York Academy of Sciences, Volume 600, Eds. Baserga and Denhardt (NYAS 1992); Milligan (1993) J. Med. Chem. 36:1923-1937; and “Antisense Research and Applications” (1993, CRC Press)). PNAs contain non-ionic backbones, such as N-(2-aminoethyl) glycine units. Phosphorothioate linkages are described in: WO 97/03211; WO 96/39154; and Mata (1997) Toxicol. Appl. Pharmacol. 144:189-197. Other synthetic backbones encompassed by this term include methyl-phosphonate linkages or alternating methyl-phosphonate and phosphodiester linkages (Strauss-Soukup (1997) Biochemistry 36: 8692-8698), and benzyl-phosphonate linkages (Samstag (1996) Antisense Nucleic Acid Drug Dev 6: 153-156).

“Probe” or “nucleic acid probe” refer to one or more nucleic acid fragments whose specific hybridization to a sample can be detected. In various embodiments, probes are arranged on a substrate surface in an array. The probe may be unlabelled, or it may contain one or more labels so that its binding to a nucleic acid can be detected. In various embodiments, a probe can be produced from any source of nucleic acids from one or more particular, pre-selected portions of a chromosome including, without limitation, one or more clones, an isolated whole chromosome, an isolated chromosome fragment, or a collection of polymerase chain reaction (PCR) amplification products.

In some embodiments, the probe may be a member of an array of nucleic acids as described in WO 96/17958. Techniques capable of producing high density arrays can also be used for this purpose (see, e.g., Fodor (1991) Science 767-773; Johnston (1998) Curr. Biol. 8: R171-8174; Schummer (1997) Biotechniques 23: 1087-1092; Kern (1997) Biotechniques 23: 120-124; and U.S. Pat. No. 5,143,854).

The sequence of the probes can be varied. In various embodiments, the probe sequence can be varied to produce probes that are substantially identical to the probes disclosed herein, but that retain the ability to hybridize specifically to the same targets or samples as the probe from which they were derived.

“Reference sample” refers to nucleic acids comprising sequences whose quantity or degree of representation, copy number, and/or sequence identity are known. Such nucleic acids serve as a reference to which one or more test samples are compared.

“Sample” refers to a material, or mixture of materials, containing one or more components of interest. Samples include, but are not limited to, material obtained from an organism and may be directly obtained from a source, such as from a biopsy or from a tumor, or indirectly obtained such as after culturing and/or processing.

“Test sample” refers to nucleic acids comprising sequences whose quantity or degree of representation, copy number, and/or sequence identity are unknown. In various embodiments, the present disclosure is directed to the detection of the quantity or degree of representation, copy number, and/or sequence identity of one or more test samples.

Reference is now made in detail to certain embodiments of arrays and methods. The disclosed embodiments are not intended to be limiting of the claims. To the contrary, the claims are intended to cover all alternatives, modifications, and equivalents.

### Arrays, Micro-Arrays and Probes

In various aspects, the present disclosure relates to the determination of copy number changes in the DNA content of a given test sample, as compared to one or more reference samples. In some embodiments, the copy number changes comprise gains or increases in the DNA content of a test sample. In some embodiments, the copy number changes comprise losses or decreases in the DNA content of a test sample. In some embodiments, the copy number changes comprise both gains or increases and losses or decreases in the DNA content of a test sample.

Determination of copy number changes can be determined by hybridizations that are performed on a solid support. For example, probes that selectively hybridize to specific chromosomal regions can be spotted onto a surface. In various aspects, the spots of probes are placed in an ordered pattern, or array, and the pattern is recorded to facilitate correlation of results. Once an array is generated, one or more test samples can be hybridized to the array. In various aspects, arrays comprise a plurality of nucleic acid probes immobilized to discrete spots (i.e., defined locations or assigned positions) on a substrate surface.

Thus, in several aspects, copy number changes of genomic loci are analyzed in an array-based approach. In some embodiments, copy number changes of genomic loci are analyzed using comparative genomic hybridization. In some embodiments, copy number changes of genomic loci are analyzed using array-based comparative genomic hybridization.

Any of a variety of arrays may be used. A number of arrays are commercially available for use from Vysis Corporation (Downers Grove, III), Spectral Genomics Inc. (Houston, Tex.), and Affymetrix Inc. (Santa Clara, Calif.). Arrays can also be custom made for one or more hybridizations.

Methods of making and using arrays are well known in the art (see, e.g., Kern et al., Biotechniques (1997), 23:120-124; Schummer et al., Biotechniques (1997), 23:1087-1092; Solinas-Toldo et al., Genes, Chromosomes & Cancer (1997), 20: 399-407; Johnston, Curr. Biol. (1998), 8: R171-R174; Bowtell, Nature Gen. (1999), Supp. 21:25-32; Watson et al., Biol. Psychiatry (1999), 45: 533-543; Freeman et al., Biotechniques (2000), 29: 1042-1046 and 1048-1055; Lockhart et al., Nature (2000), 405: 827-836; Cuzin, Transfus. Clin. Biol. (2001), 8:291-296; Zarrinkar et al., Genome Res. (2001), 11: 1256-1261; Gabig et al., Acta Biochim. Pol. (2001), 48: 615-622; and Cheung et al., Nature (2001), 40: 953-958; see also, e.g., U.S. Pat. Nos. 5,143,854; 5,434,049; 5,556,752; 5,632,957; 5,700,637; 5,744,305; 5,770,456; 5,800,992; 5,807,522; 5,830,645; 5,856,174; 5,959,098; 5,965,452; 6,013,440; 6,022,963; 6,045,996; 6,048,695; 6,054,270; 6,258,606; 6,261,776; 6,277,489; 6,277,628; 6,365,349; 6,387,626; 6,458,584; 6,503,711; 6,516,276; 6,521,465; 6,558,907; 6,562,565; 6,576,424; 6,587,579; 6,589,726; 6,594,432; 6,599,693; 6,600,031; and 6,613,893).

Substrate surfaces suitable for use in the generation of an array can be made of any rigid, semi-rigid or flexible material that allows for direct or indirect attachment (i.e., immobilization) of nucleic acid probes to the substrate surface. Suitable materials include, without limitation, cellulose (see, e.g., U.S. Pat. No. 5,068,269), cellulose acetate (see, e.g., U.S. Pat. No. 6,048,457), nitrocellulose, glass (see, e.g., U.S. Pat. No. 5,843,767), quartz and/or other crystalline substrates such as gallium arsenide, silicones (see, e.g., U.S. Pat. No. 6,096,817), plastics and plastic copolymers (see, e.g., U.S. Pat. Nos. 4,355,153; 4,652,613; and 6,024,872), membranes and gels (see, e.g., U.S. Pat. No. 5,795,557), and paramagnetic or supramagnetic microparticles (see, e.g., U.S. Pat. No. 5,939,261). When fluorescence is to be detected, arrays comprising cyclo-olefin polymers may be used (see, e.g., U.S. Pat. No. 6,063,338). The presence of reactive functional chemical groups (such as, for example, hydroxyl, carboxyl, and amino groups) present on the surface of the substrate material can be used to directly or indirectly attach nucleic acid probes to the substrate surface.

More than one copy of each nucleic acid probe may be spotted onto an array. For example, each nucleic acid probe may be spotted onto an array once, in duplicate, in triplicate, or more, depending on the desired application. Multiple spots of the same probe allows for assessment of the reproducibility of the results obtained.

Related nucleic acid probes may also be grouped together, in probe elements, on an array. For example, a single probe element may include a plurality of spots of related nucleic acid probes, which are of different lengths but that comprise substantially the same sequence or that are derived from the sequence of a specific genomic locus. Alternatively, a single probe element may include a plurality of spots of related nucleic acid probes that are fragments of different lengths resulting from digestion of more than one copy of a cloned nucleic acid. An array may contain a plurality of probe elements and probe elements may be arranged on an array at different densities.

Array-immobilized nucleic acid probes may be nucleic acids that contain sequences from genes (e.g., from a genomic library) including, for example, sequences that collectively cover a substantially complete genome, or any one or more subsets of a genome. In various embodiments, the sequences of the nucleic acid probes on an array comprise those for which comparative copy number information is desired. In some embodiments, to obtain DNA sequence copy number information across an entire genome, an array comprising nucleic acid probes covering a whole genome or a substantially complete genome is used. In some embodiments, at least one relevant genomic locus has been determined and is used in an array, such that there is no need for genome-wide hybridization. In some embodiments, a plurality of relevant genomic loci have been determined and are used in an array, such that there is no need for genome-wide hybridization. In some embodiments, the array comprises a plurality of specific nucleic acid probes that originate from a discrete set of genes or genomic loci and whose copy number, in association with the type of condition or tumor is to be tested, is known. Additionally, the array may comprise nucleic acid probes that will serve as positive or negative controls. In some embodiments, the array comprises a plurality of nucleic acid sequences derived from karyotypically normal genomes.

The probes may be generated by any number of known techniques (see, e.g., Tijssen, Laboratory Techniques in Biochemistry and Molecular Biology-Hybridization with Nucleic Acid Probes Part I, Ch. 2, “Overview of principles of hybridization and the strategy of nucleic acid probe assays” (1993), Elsevier, N.Y.; Sambrook et al., Molecular Cloning: A Laboratory Manual (3rd ed.) Vol. 1-3 (2001), Cold Spring Harbor Laboratory, Cold Spring Harbor Press, N.Y.; Innis (Ed.) “PCR Strategies” (1995), Academic Press: New York, N.Y.; and Ausubel (Ed.), “Short Protocols in Molecular Biology” 5th Ed. (2002), John Wiley & Sons). Nucleic acid probes may be obtained and manipulated by cloning into various vehicles. They may be screened and re-cloned or amplified from any source of genomic DNA.

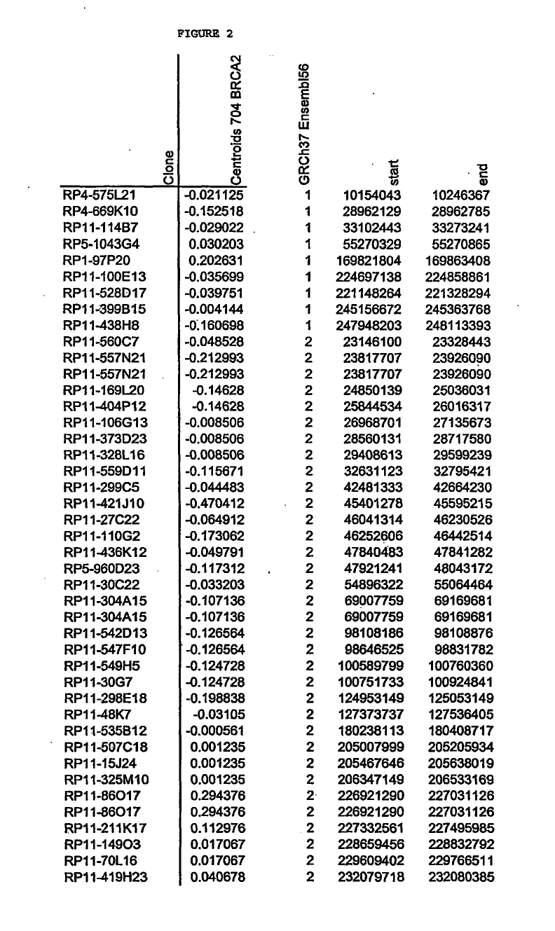

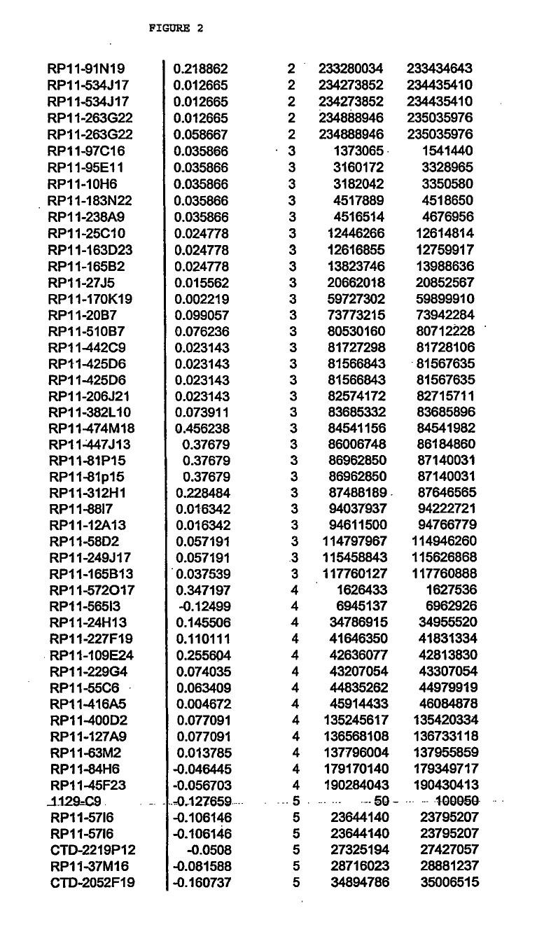

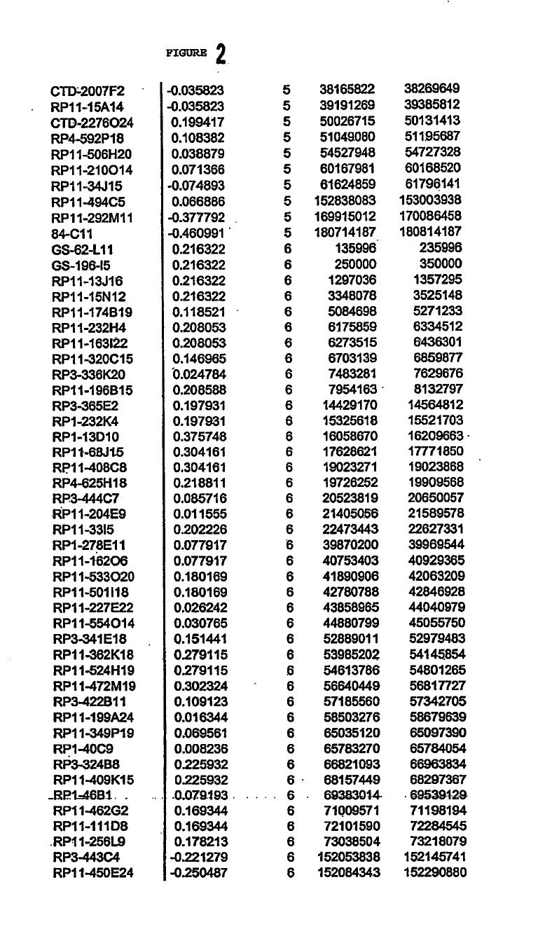

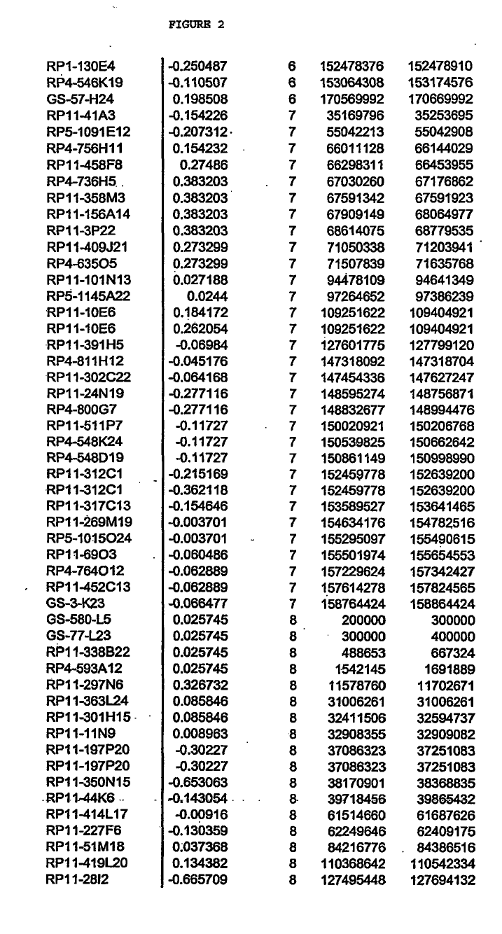

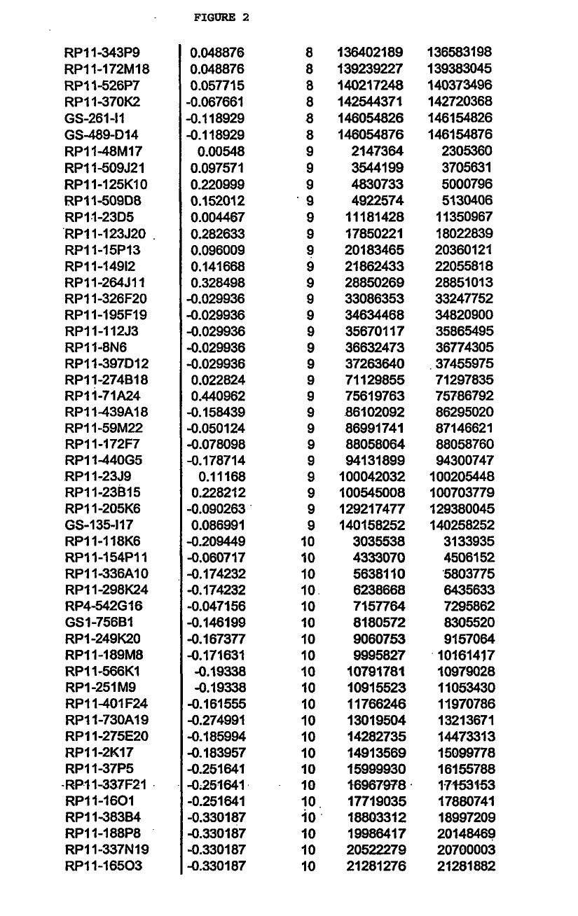

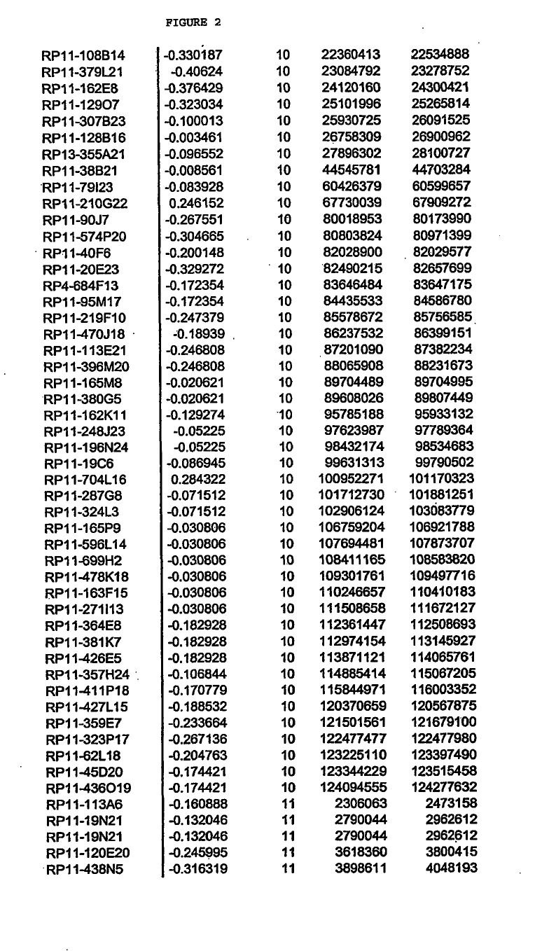

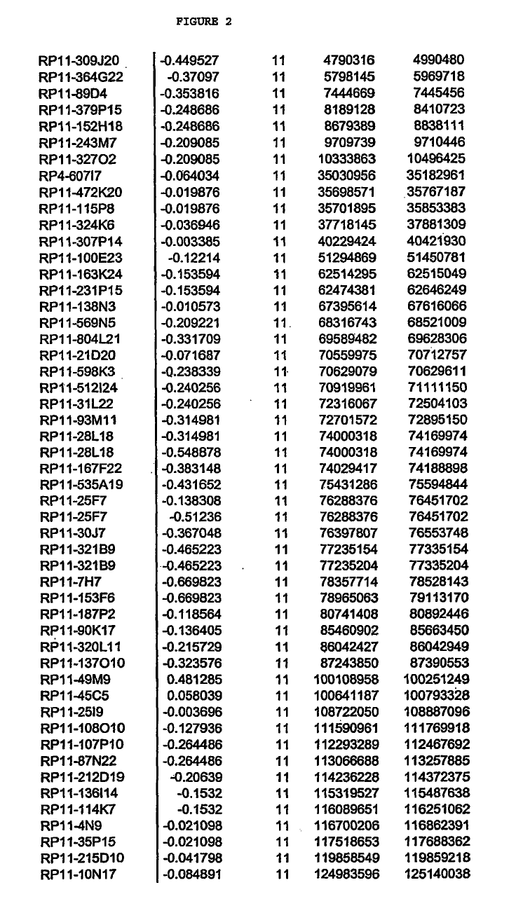

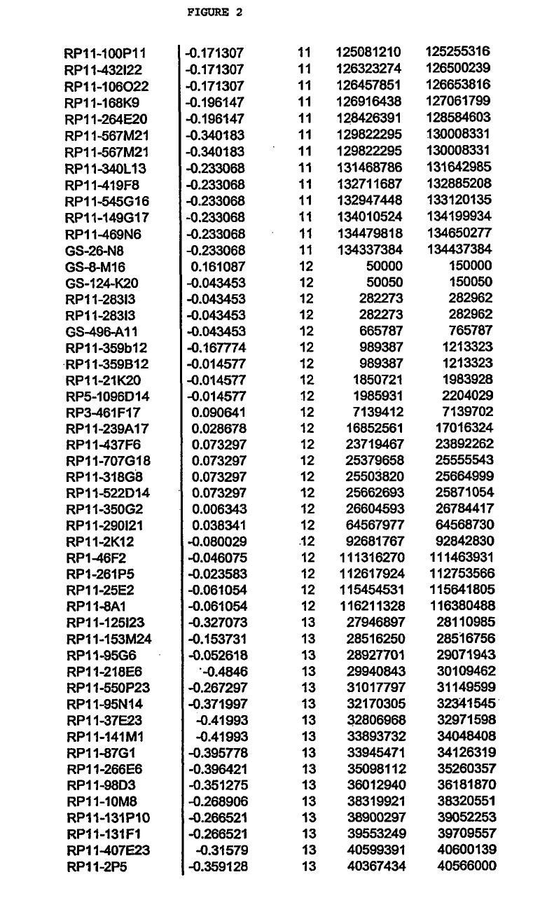

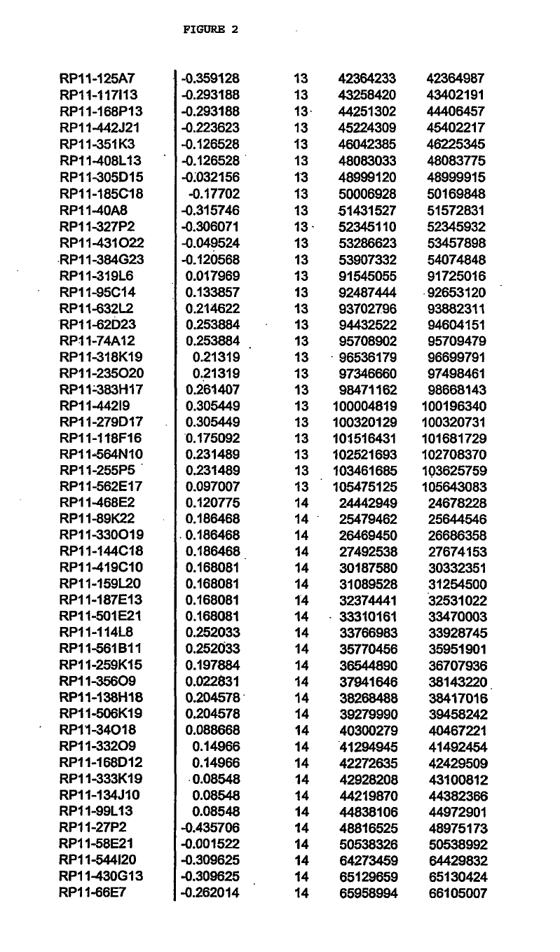

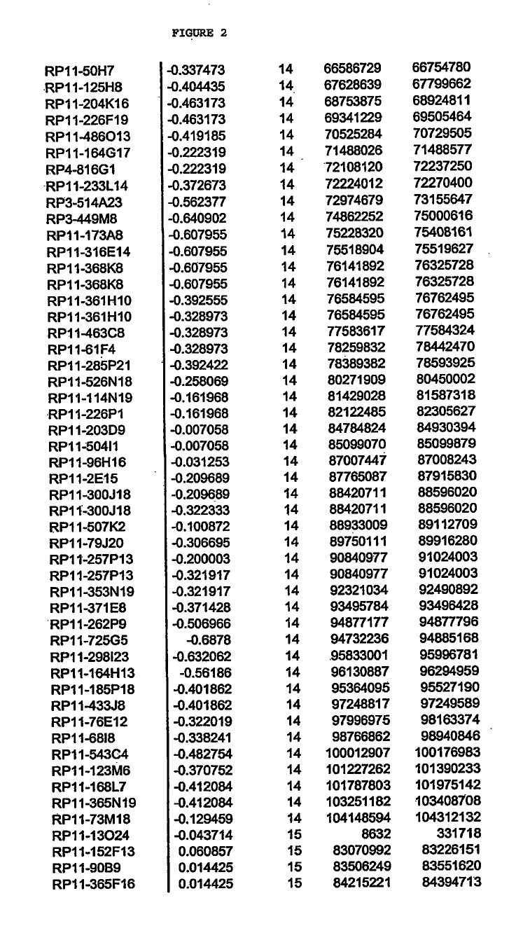

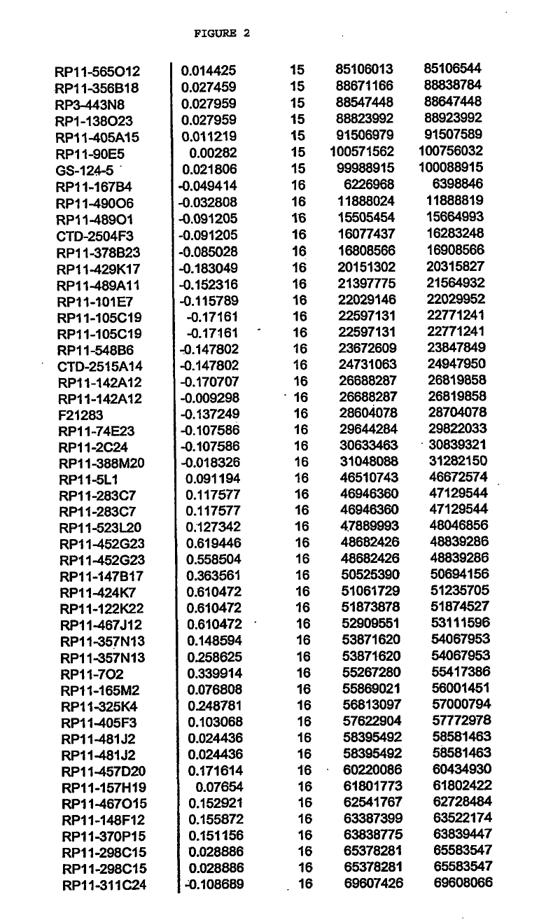

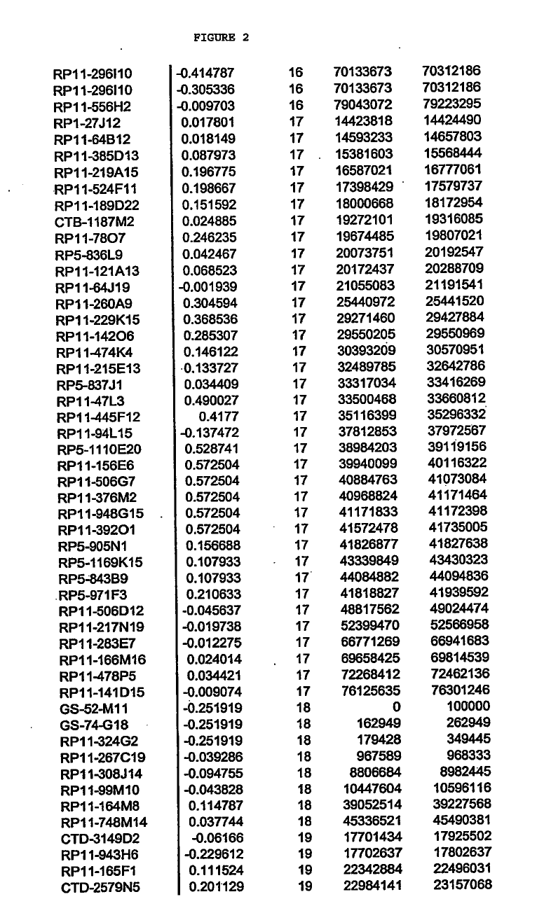

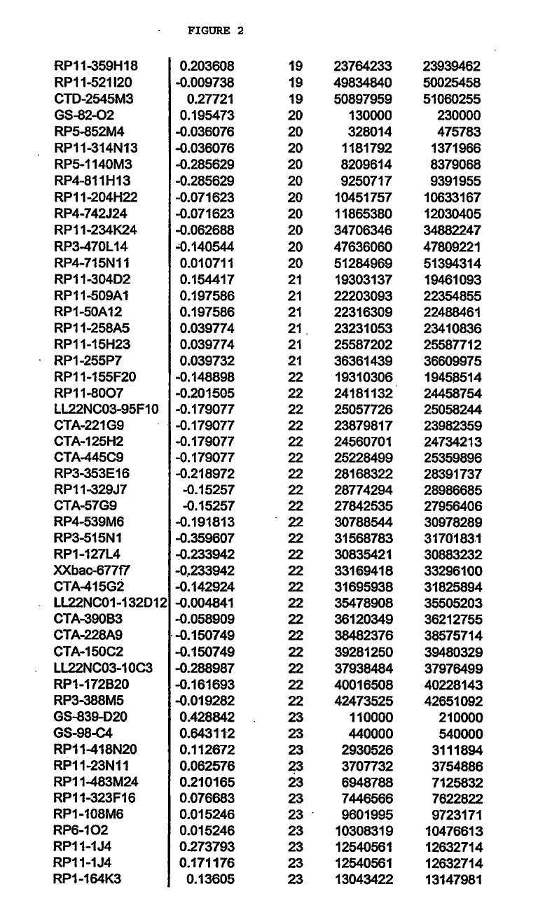

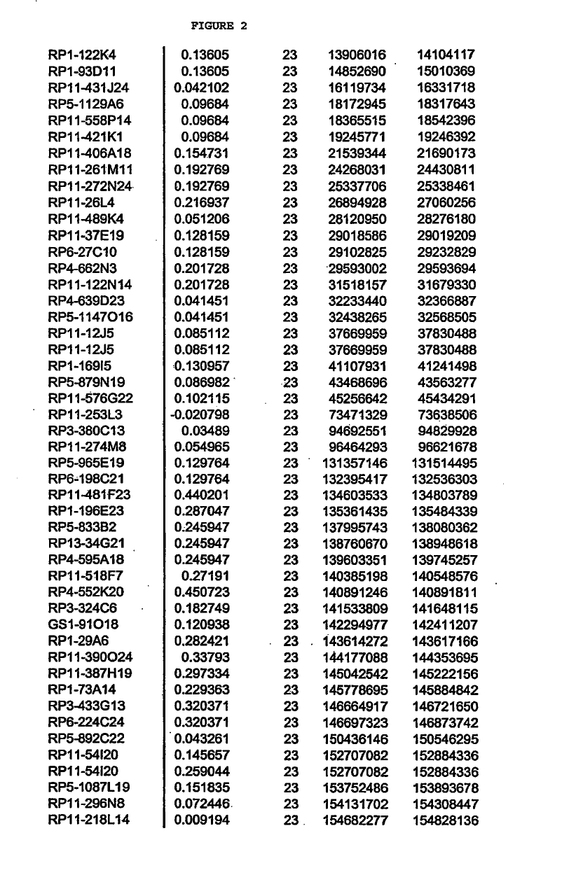

Nucleic acid probes may also be obtained and manipulated by cloning into vehicles including, for example, recombinant viruses, cosmids, or plasmids. Nucleic acid probes may also be synthesized in vitro by chemical techniques (see, e.g., Nucleic Acids Res. (1997), 25: 3440-3444; Blommers et al., Biochemistry (1994), 33: 7886-7896; and Frenkel et al., Free Radic. Biol. Med. (1995), 19: 373-380). Probes may vary in size from synthetic oligonucleotide probes and/or PCR-type amplification primers of a few base pairs in length to artificial chromosomes of more than 1 megabases in length. In various embodiments, probes comprise at least 10, at least 12, at least 15, at least 18, at least 20, at least 22, at least 30, at least 50 or at least 100 contiguous nucleotides of a sequence present in a BAC clone set forth in FIG. 2. In various embodiments, probes also comprise at least 10, at least 12, at least 15, at least 18, at least 20, at least 22, at least 30, at least 50 or at least 100 contiguous nucleotides of a sequence present in one or more reference samples. In some embodiments, probes comprise a sequence that is unique in a genome. In some embodiments, probes comprise a sequence that is unique in the human genome.

Probes may be obtained from any number of commercial sources. For instance, several P1 clones are available from the DuPont P1 library (see, e.g., Shepard et al., Proc. Natl. Acad. Sci. USA (1994), 92: 2629), and available commercially from Incyte Corporation (Wilmington, Del.). Various libraries spanning entire chromosomes are available commercially from Clontech Laboratories, Inc. (Mountain View, Calif.), or from the Los Alamos National Laboratory (Los Alamos, Calif.). In various aspects, the present disclosure relates to the use of the human 3600 BAC/PAC genomic clone set, covering the full human genome at 1 Mb spacing, obtained from the Wellcome Trust Sanger Institute (Hinxton, Cambridge, UK).

In some embodiments, the nucleic acid probes are derived from mammalian artificial chromosomes (MACs) and/or human artificial chromosomes (HACs), which can contain inserts from about 5 to 400 kilobases (kb) (see, e.g., Roush, Science (1997), 276: 38-39; Rosenfeld, Nat. Genet. (1997), 15: 333-335; Ascenzioni et al., Cancer Lett. (1997), 118: 135-142; Kuroiwa et al., Nat. Biotechnol. (2000), 18: 1086-1090; Meija et al., Am. J. Hum. Genet. (2001), 69: 315-326; and Auriche et al., EMBO Rep. (2001), 2: 102-107).

In some embodiments, the nucleic acid probes are derived from satellite artificial chromosomes or satellite DNA-based artificial chromosomes (SATACs). SATACs can be produced by inducing de novo chromosome formation in cells of varying mammalian species (see, e.g., Warburton et al., Nature (1997), 386: 553-555; Csonka et al., J. Cell. Sci. (2000), 113: 3207-3216; and Hadlaczky, Curr. Opin. Mol. Ther. (2001), 3: 125-132).

In some embodiments, the nucleic acid probes are derived from yeast artificial chromosomes (YACs), 0.2-1 megabses in size. YACs have been used for many years for the stable propagation of genomic fragments of up to one million base pairs in size (see, e.g., Feingold et al., Proc. Natl. Acad. Sci. USA (1990), 87:8637-8641; Adam et al., Plant J. (1997), 11: 1349-1358; Tucker et al., Gene (1997), 199: 25-30; and Zeschnigk et al., Nucleic Acids Res. (1999), 27: E30).

In some embodiments, the nucleic acid probes are derived from bacterial artificial chromosomes (BACs) up to 300 kb in size. BACs are based on the E. coli F factor plasmid system and are typically easy to manipulate and purify in microgram quantities (see, e.g., Asakawa et al., Gene (1997), 191: 69-79; and Cao et al., Genome Res. (1999), 9: 763-774).

In some embodiments, the nucleic acid probes are derived from P1 artificial chromosomes (PACs), about 70-100 kb in size. PACs are bacteriophage P1-derived vectors (see, e.g., Ioannou et al., Nature Genet. (1994), 6: 84-89; Boren et al., Genome Res. (1996), 6: 1123-1130; Nothwang et al., Genomics (1997), 41: 370-378; Reid et al., Genomics (1997), 43: 366-375; and Woon et al., Genomics (1998), 50: 306-316).

In some embodiments, the array comprises a series of separate wells or chambers on the substrate surface, into which probes may be immobilized as described herein. The probes can be immobilized in the separate wells or chambers and hybridization can take place within the wells or chambers. In various embodiments, the arrays can be selected from chips, microfluidic chips, microtiter plates, Petri dishes, and centrifuge tubes. Robotic equipment has been developed for these types of arrays that permit automated delivery of reagents into the separate wells or chambers which allow the amount of the reagents used per hybridization to be sharply reduced. Examples of chip and microfluidic chip techniques can be found, for example, in U.S. Pat. No. 5,800,690; Orchid, “Running on Parallel Lines” New Scientist (1997); McCormick et al., Anal. Chem. (1997), 69:2626-30; and Turgeon, “The Lab of the Future on CD-ROM?” Medical Laboratory Management Report. December 1997, p. 1.

In some embodiments, arrays may be generated by isolating DNA from one or more artificial chromosomes, such as for example BACs, according to standard procedures. For example, in some embodiments, DNA can be isolated from one or more BACs using a Qiawell plasmid kit (Qiagen, Chatsworth, Calif.). Total DNA can be amplified from the insert sites of the BACs via degenerate oligonucleotide primed PCR using a set of degenerate primers with a C6—NH₂ modification at their 5′ end for covalent attachment to a substrate surface. The substrates may be any type suitable for such use including, for example, CODELINK™ glass slides (Corning, Cambridge, UK). Covalent attachment to the substrate can occur via the manufacturer's suggested protocols, or via other detailed protocols (such as those described in Pinkel et al., Nature Genetics (1998), 20:207-211) with some modifications (such as those described in Alers et al. 1999). The DNA obtained after PCR amplification can then be spotted onto the substrate surface for covalent attachment thereto. The DNA may be spotted as a single site, in duplicate or in triplicate on the substrate surface.

### BRCA2 Arrays

In various aspects, the present disclosure relates to the use of a BRCA2 array to identify breast cancers with a deficient homologous recombination-dependent double strand break DNA repair system due to BRCA2 dysfunction and to thus distinguish BRCA2-associated tumors from sporadic tumors. Therefore, in various aspects, the present disclosure relates to the use of a BRCA2 array comprising a unique BRCA2 aCGH profile to distinguish BRCA2-associated tumors from sporadic tumors by detecting phenotypic genetic traits associated with deficiencies in the BRCA2 gene. In further aspects, the present disclosure relates to the use of a BRCA2 array comprising a unique BRCA2 aCGH profile to distinguish BRCA2-associated tumors from sporadic tumors by detecting phenotypic genetic traits associated with deficiencies in non-BRCA2 genes, wherein the deficiencies negatively affect the homologous recombination-dependent double strand break DNA repair pathway of which BRCA2 is a component.

In various embodiments, a BRCA2 array comprising a BRCA2 aCGH profile for distinguishing BRCA2-associated tumors from sporadic tumors, is provided. In various aspects, arrays provided by the present disclosure, which in some embodiments are BRCA2 arrays, can comprise at least one, or in some embodiments a plurality, of the BAC clones of FIG. 2 immobilized on a substrate surface. In various aspects, arrays provided by the present disclosure, which in some embodiments are BRCA2 arrays, can comprise at least one, or in some embodiments a plurality, of the BAC clones of FIG. 2 immobilized to discrete spots on a substrate surface. In some embodiments, an array comprises all 704 of the BAC clones set forth in FIG. 2 immobilized on a substrate surface. In some embodiments, an array comprises all 704 of the BAC clones set forth in FIG. 2, immobilized to a plurality of discrete spots on a substrate surface. In some embodiments, arrays provided by the present disclosure comprise a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, the BAC clones comprising the arrays of the preceding sentence are immobilized to a plurality of discrete spots on a substrate surface. In some embodiments, arrays provided by the present disclosure comprise a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10. In some embodiments, the BAC clones comprising the arrays of the preceding sentence are immobilized to a plurality of discrete spots on a substrate surface. In various aspects, arrays provided by the present disclosure can also comprise at least one, or in some embodiments a plurality, of nucleic acid probes from a reference sample immobilized on a substrate surface. In various aspects, arrays provided by the present disclosure can also comprise at least one, or in some embodiments a plurality, of nucleic acid probes from a reference sample immobilized to discrete spots on a substrate surface. In some embodiments, a BRCA2 array is used to detect BRCA2-associated genomic copy number variations in a test sample, as compared to a reference sample, at one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array is used to detect BRCA2-associated genomic copy number variations in a test sample, as compared to a reference sample, at one, or a plurality, of the genomic loci selected from 4p13-12, 13q12.2-21.1, 13q31.3-33.1, 14q23.2-32.33, 16q12.1-21, 17q11.1-12 and 17q21.2-21.31.

In some embodiments, a BRCA2 array is used to detect an increase in genomic copy numbers in a test sample, as compared to a reference sample, at one, or a plurality, of the genomic loci selected from 6p25.3-11.1, 6q12-13 and 13q31.3-33.1. In some embodiments, a BRCA2 array is used to detect a decrease in genomic copy numbers in a test sample, as compared to a reference sample, at one, or a plurality, of the genomic loci selected from 10q22.3-26.13, 13q12.2-21.1 and 14q23.2-32.33. In the aforementioned embodiments, detection of genomic copy number variations in the test sample, as compared to the reference sample, classifies the test sample as from a BRCA2-associated tumor.

In some embodiments, a BRCA2 array is used to detect an increase in genomic copy numbers in a test sample, as compared to a reference sample, at the genomic locus 16p12.3-11.2. In some embodiments, a BRCA2 array is used to detect a decrease in genomic copy numbers in a test sample, as compared to a reference sample, at one, or a plurality, of the genomic loci selected from 2q36.3-37.1, 4p13-12, 16q12.1-21, 17q11.1-12 and 17q21.2-21.31. In the aforementioned embodiments, detection of genomic copy number variations in the test sample, as compared to the reference sample, classifies the test sample as from a sporadic tumor.

The genomic loci may be detected individually, or in any combination of two or more loci. In some embodiments, a BRCA2 array is used that is capable of detecting BRCA2-associated genomic copy number variations in all 25 of the above-listed chromosomal loci. In some embodiments, a BRCA2 array is used that is capable of detecting BRCA2-associated genomic copy number variations at a number of the above-listed genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, a BRCA2 array is used that is capable of detecting BRCA2-associated genomic copy number variations at a number of the above-listed genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2. In some embodiments, a BRCA2 array is used that is capable of detecting BRCA2-associated genomic copy number variations in all 25 of the BRCA2-associated genomic loci set forth in FIG. 1A. In some embodiments, a BRCA2 array is used that is capable of detecting BRCA2-associated genomic copy number variations in all 7 of the BRCA2-associated genomic loci set forth in FIG. 1B. In some embodiments, a BRCA2 array is used that is capable of detecting BRCA2-associated genomic copy number variations in at least one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array is used that is capable of detecting BRCA2-associated genomic copy number variations in at least one, or a plurality, of the genomic loci selected from 4p13-12, 13q12.2-21.1, 13q31.3-33.1, 14q23.2-32.33, 16q12.1-21, 17q11.1-12 and 17q21.2-21.31. In some embodiments, a BRCA2 array is used that is capable of detecting BRCA2-associated genomic copy number variations in at least one, or a plurality, of the genomic loci selected from 6p25.3-11.1, 6q12-13 and 13q31.3-33.1. In some embodiments, a BRCA2 array is used that is capable of detecting BRCA2-associated genomic copy number variations in at least one, or a plurality, of the genomic loci selected from 10q22.3-26.13, 13q12.2-21.1 and 14q23.2-32.33. In some embodiments, a BRCA2 array is used that is capable of detecting BRCA2-associated genomic copy number variations in at the genomic locus 16p12.3-11.2. In some embodiments, a BRCA2 array is used that is capable of detecting BRCA2-associated genomic copy number variations in at least one, or a plurality, of the genomic loci selected from 2q36.3-37.1, 4p13-12, 16q12.1-21, 17q11.1-12 and 17q21.2-21.31. In each of the aforementioned embodiments, detection of BRCA2-associated genomic copy number variations classifies the test sample as from either a BRCA2-associated tumor or from a sporadic tumor.

The BRCA2 arrays comprise at least one probe. In various embodiments, the BRCA2 arrays comprise a plurality of probes. In some embodiments, the BRCA2 arrays comprise a plurality of probes, wherein the probes comprise nucleic acid sequences derived from BAC clones. The BRCA2-associated genomic loci set forth in FIG. 1A are bounded by the BAC probes set forth in FIG. 2. The BRCA2-associated genomic loci set forth in FIG. 1B are bounded by a sub-set of the BAC probes set forth in FIG. 2. In some embodiments, arrays capable of detecting BRCA2-associated genomic copy number variations comprise at least one, or a plurality, of probes derived from the BAC clones of FIG. 2. The BAC clones set forth in FIG. 2 are not intended to be limiting in any way, and other probes within the BRCA2-associated genomic loci of FIGS. 1A and 1B can also be used in the BRCA2 arrays. In some embodiments, arrays capable of detecting BRCA2-associated genomic copy number variations comprise all 704 of the BAC clones set forth in FIG. 2. In some embodiments, arrays capable of detecting BRCA2-associated genomic copy number variations comprise a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, arrays capable of detecting BRCA2-associated genomic copy number variations comprise a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

In some embodiments, a BRCA2 array capable of detecting BRCA2-associated genomic copy number variations comprises at least one, or a plurality, of probes that independently hybridize to a genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array capable of detecting BRCA2-associated genomic copy number variations comprises at least one, or a plurality, of probes that independently hybridize to a genomic locus selected from 4p13-12, 13q12.2-21.1, 13q31.3-33.1, 14q23.2-32.33, 16q12.1-21, 17q11.1-12 and 17q21.2-21.31. In some embodiments, a BRCA2 array capable of detecting BRCA2-associated genomic copy number variations comprises at least one, or a plurality, of probes that independently hybridize to a genomic locus selected from 6p25.3-11.1, 6q12-13 and 13q31.3-33.1. In some embodiments, a BRCA2 array capable of detecting BRCA2-associated genomic copy number variations comprises at least one, or a plurality, of probes that independently hybridize to a genomic locus selected from 10q22.3-26.13, 13q12.2-21.1 and 14q23.2-32.33. In some embodiments, a BRCA2 array capable of detecting BRCA2-associated genomic copy number variations comprises at least one, or a plurality, of probes that independently hybridize to the genomic locus 16p12.3-11.2. In some embodiments, a BRCA2 array capable of detecting BRCA2-associated genomic copy number variations comprises at least one, or a plurality, of probes that independently hybridize to a genomic locus selected from 2q36.3-37.1, 4p13-12, 16q12.1-21, 17q11.1-12 and 17q21.2-21.31. In these embodiments, the number of probes used can be determined as described above, the probes are as defined above and/or the probes may be obtained in methods as described above.

In some embodiments, BRCA2 arrays capable of detecting BRCA2-associated genomic copy number variations comprise at least one, or a plurality, of probes, wherein the probes comprise at least one, or a plurality of the distinct BAC clones of FIG. 2. In some embodiments, BRCA2 arrays capable of detecting BRCA2-associated genomic copy number variations comprise at least one, or a plurality of probes, wherein the probes comprise at least one, or a plurality, of the BAC clones of FIG. 2, and wherein the probes specifically hybridize to at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In some embodiments, BRCA2 arrays capable of detecting BRCA2-associated genomic copy number variations comprise a plurality of probes, wherein the nucleic acid sequences of the probes are unique to the genomic loci set forth in FIG. 1A. In some embodiments, BRCA2 arrays capable of detecting BRCA2-associated genomic copy number variations comprise a plurality of probes, wherein the probes comprise a plurality of BAC clones specific to all of the genomic loci set forth in FIG. 1A. In some embodiments, BRCA2 arrays capable of detecting BRCA2-associated genomic copy number variations comprise at least one, or a plurality of probes, wherein the probes comprise at least one, or a plurality, of the BAC clones of FIG. 2, and wherein the probes specifically hybridize to at least 1, at least 2, at least 3, at least 4, at least 5, at least 6 or at least 7 of the genomic loci set forth in FIG. 1B. In some embodiments, BRCA2 arrays capable of detecting BRCA2-associated genomic copy number variations comprise a plurality of probes, wherein the nucleic acid sequences of the probes are unique to the genomic loci set forth in FIG. 1B. In some embodiments, BRCA2 arrays capable of detecting BRCA2-associated genomic copy number variations comprise a plurality of probes, wherein the probes comprise a plurality of BAC clones specific to all of the genomic loci set forth in FIG. 1B. In some embodiments, BRCA2 arrays capable of detecting BRCA2-associated genomic copy number variations comprise at least one, or a plurality, of probes, wherein the probes comprise at least 4, at least 5, at least 6, at least 7, at least 8, at least 9, at least 10, at least 15, at least 20, at least 30, at least 50, at least 60, at least 80 or at least 100 of the distinct BAC clones of FIG. 2. In some embodiments, BRCA2 arrays capable of detecting BRCA2-associated genomic copy number variations comprise at least three probes, wherein the probes comprise greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, or greater than 700 distinct BAC clones of FIG. 2 that specifically hybridize to at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In some embodiments, BRCA2 arrays capable of detecting BRCA2-associated genomic copy number variations comprise at least one, or a plurality, of probes, wherein the probes comprise greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, or greater than 700 distinct BAC clones of FIG. 2 that specifically hybridize to at least 1, at least 2, at least 3, at least 4, at least 5, at least 6 or at least 7 of the genomic loci set forth in FIG. 1B.

In various embodiments, BRCA2 arrays capable of detecting BRCA2-associated genomic copy number variations that comprise at least one, or a plurality, of probes, and/or that comprise at least one, or a plurality, of distinct BAC clones, allow for the individual analysis of at least one, or a plurality, of distinct genomic loci. Therefore, in some embodiments, the probes, and/or the distinct BAC clones, capable of detecting BRCA2-associated genomic copy number variations are arranged on the BRCA2 arrays in a positionally-addressable manner.

In various embodiments, BRCA2 arrays capable of detecting BRCA2-associated genomic copy number variations comprise at least one, or a plurality, of distinct BAC clones, wherein the distinct BAC clones represent at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In various embodiments, BRCA2 arrays capable of detecting BRCA2-associated genomic copy number variations comprise at least one, or a plurality, of distinct BAC clones, wherein the distinct BAC clones represent at least 1, at least 2, at least 3, at least 4, at least 5, at least 6 or at least 7 of the genomic loci set forth in FIG. 1B. In various embodiments, BRCA2 arrays capable of detecting BRCA2-associated genomic copy number variations comprise at least one, or a plurality, of distinct BAC clones, wherein the distinct BAC clones represent all 25 of the genomic loci set forth in FIG. 1A. In various embodiments, BRCA2 arrays capable of detecting BRCA2-associated genomic copy number variations comprise at least one, or a plurality, of distinct BAC clones, wherein the distinct BAC clones represent all 7 of the genomic loci set forth in FIG. 1B.

### Array Comparative Genomic Hybridization

In various aspects, the present disclosure relates to the analysis of tumor cell samples by array-based comparative genomic hybridization. Array comparative genomic hybridization (aCGH) is a technique that is used to detect genomic copy number variations at a higher level of resolution than chromosome-based comparative genomic hybridization. In aCGH, nucleic acids from a test sample and nucleic acids from a reference sample are labelled differentially. The test sample and the reference sample are then hybridized to an array comprising a plurality of probes. The ratio of the signal intensity of the test sample to that of the reference sample is then calculated, to measure the copy number changes for a particular location in the genome. The difference in the signal ratio determines whether the total copy numbers of the nucleic acids in the test sample are increased or decreased as compared to the reference sample. The test sample and the reference sample may be hybridized to the array separately or they may be mixed together and hybridized simultaneously. Exemplary methods of performing aCGH can be found, for example, in U.S. Pat. Nos. 5,635,351; 5,665,549; 5,721,098; 5,830,645; 5,856,097; 5,965,362; 5,976,790; 6,159,685; 6,197,501; and 6,335,167; European Patent Nos. EP 1 134 293 and EP 1 026 260; van Beers et al., Brit. J. Cancer (2006), 20; Joosse et al., BMC Cancer (2007), 7:43; Pinkel et al., Nat. Genet. (1998), 20: 207-211; Pollack et al., Nat. Genet. (1999), 23: 41-46; and Cooper, Breast Cancer Res. (2001), 3: 158-175.

Samples that are labelled differentially are labelled such that one of the two samples is labelled with a first detectable agent and the other of the two samples is labelled with a second detectable agent, wherein the first detectable agent and the second detectable agent produce distinguishable signals. Detectable agents that produce distinguishable signals can include, for example, matched pairs of fluorescent dyes.

In some embodiments, the methods of the present disclosure comprise analyzing at least one test sample of tumor DNA from a subject by array-based comparative genomic hybridization to obtain information relating to the copy number aberrations present in the sample(s), if any; and, based on the information obtained, classifying the tumor as a BRCA2-related tumor, a BRCAlikeness tumor or a sporadic tumor.

Information relating to the copy number aberrations present in a sample can include, for example, a gain of genetic material at one or more genomic loci, a loss of genetic material at one or more genomic loci, chromosomal abnormalities at one or more genomic loci, and genome copy number changes at one or more genomic loci. This information is obtained by analyzing the difference in signal intensity between the test sample and a reference sample at one or more genomic loci. The analysis can be performed using any of a variety of methods, means and variations thereof for carrying out array-based comparative genomic hybridization.

In various embodiments, the reference sample is a nucleic acid sample that is representative of a normal, non-diseased state, for example a non-tumor/non-cancer cell, and contains a normal amount of copy numbers of the complement of the genomic loci being tested. The reference sample may be derived from a genomic nucleic acid sample from a normal and/or healthy individual or from a pool of such individuals. In various embodiments, the reference sample does not comprise any tumor or cancerous nucleic acids. In some embodiments, the reference sample is derived from a pool of female subjects. In some embodiments, the reference sample comprises pooled genomic DNA isolated from tissue samples (e.g. lymphocytes) from a plurality (e.g. at least 4-10) of healthy female subjects. In some embodiments, the reference sample comprises an artificially-generated population of nucleic acids designed to approximate the copy number level from each tested genomic region, or fragments of each tested genomic region. In some embodiments, the reference sample is derived from normal, non-cancerous cell lines or from cell line samples.

Test samples may be obtained from a biological source comprising tumor cells, and reference samples may be obtained from a biological source comprising normal reference cells, by any suitable method of nucleic acid isolation and/or extraction. In various aspects, the test sample and the reference sample are DNA. Methods of DNA extraction are well known in the art. A classical DNA isolation protocol is based on extraction using organic solvents, such as a mixture of phenol and chloroform, followed by precipitation with ethanol (see, e.g., Sambrook et al., supra). Other methods include salting out DNA extraction, trimethylammonium bromide salt extraction, and guanidinium thiocyanate extraction. Additionally, there are numerous DNA extraction kits that are commercially available from, for example, BD Biosciences Clontech (Palo Alto, Calif.), Epicentre Technologies (Madison, Wis.), Gentra Systems, Inc. (Minneapolis, Minn.), MicroProbe Corp. (Bothell, Wash.), Organon Teknika (Durham, N.C.), and Qiagen Inc. (Valencia, Calif.).

The test samples and the reference samples may be differentially labelled with any detectable agents or moieties. In various embodiments, the detectable agents or moieties are selected such that they generate signals that can be readily measured and such that the intensity of the signals is proportional to the amount of labelled nucleic acids present in the sample. In various embodiments, the detectable agents or moieties are selected such that they generate localized signals, thereby allowing resolution of the signals from each spot on an array.

Methods for labeling nucleic acids are well-known in the art. For exemplary reviews of labeling protocols, label detection techniques and recent developments in the field, see: Kricka, Ann. Clin. Biochem. (2002), 39: 114-129; van Gijlswijk et al., Expert Rev. Mol. Diagn. (2001), 1: 81-91; and Joos et al., J. Biotechnol. (1994), 35: 135-153. Standard nucleic acid labeling methods include: incorporation of radioactive agents, direct attachment of fluorescent dyes or of enzymes, chemical modification of nucleic acids to make them detectable immunochemically or by other affinity reactions, and enzyme-mediated labeling methods including, without limitation, random priming, nick translation, PCR and tailing with terminal transferase. Other suitable labeling methods include psoralen-biotin, photoreactive azido derivatives, and DNA alkylating agents. In various embodiments, test sample and reference sample nucleic acids are labelled by Universal Linkage System, which is based on the reaction of monoreactive cisplatin derivatives with the N7 position of guanine moieties in DNA (see, e.g., Heetebrij et al., Cytogenet. Cell. Genet. (1999), 87: 47-52).

Any of a wide variety of detectable agents or moieties can be used to label test and/or reference samples. Suitable detectable agents or moieties include, but are not limited to: various ligands; radionuclides such as, for example, ³²P, ³⁵S, ³H, ¹⁴C, ¹²⁵I, ¹³¹I, and others; fluorescent dyes; chemiluminescent agents such as, for example, acridinium esters, stabilized dioxetanes, and others; microparticles such as, for example, quantum dots, nanocrystals, phosphors and others; enzymes such as, for example, those used in an ELISA, horseradish peroxidase, beta-galactosidase, luciferase, alkaline phosphatase and others; colorimetric labels such as, for example, dyes, colloidal gold and others; magnetic labels such as, for example, Dynabeads™; and biotin, dioxigenin or other haptens and proteins for which antisera or monoclonal antibodies are available.

In some embodiments, the test samples and the reference samples are labelled with fluorescent dyes. Suitable fluorescent dyes include, without limitation, Cy-3, Cy-5, Texas red, FITC, Spectrum Red, Spectrum Green, phycoerythrin, rhodamine, and fluorescein, as well as equivalents, analogues and/or derivatives thereof. In some embodiments, the fluorescent dyes selected display a high molar absorption coefficient, high fluorescence quantum yield, and photostability. In some embodiments, the fluorescent dyes exhibit absorption and emission wavelengths in the visible spectrum (i.e., between 400 nm and 750 nm) rather than in the ultraviolet range of the spectrum (i.e., lower than 400 nm). In some embodiments, the fluorescent dyes are Cy-3 (3-N,N′-diethyltetramethylindo-dicarbocyanine) and Cy-5 (5-N,N′-diethyltetramethylindo-dicarbocyanine). Cy-3 and Cy-5 form a matched pair of fluorescent labels that are compatible with most fluorescence detection systems for array-based instruments. In some embodiments, the fluorescent dyes are Spectrum Red and Spectrum Green.

A key component of aCGH is the hybridization of a test sample and a reference sample to an array. Exemplary hybridization and wash protocols are described, for example, in Sambrook et al. (2001), supra; Tijssen (1993), supra; and Anderson (Ed.), “Nucleic Acid Hybridization” (1999), Springer Verlag: New York, N.Y. In some embodiments, the hybridization protocols used for aCGH are those of Pinkel et al., Nature Genetics (1998), 20:207-211. In some embodiments, the hybridization protocols used for aCGH are those of Kallioniemi, Proc. Natl. Acad. Sci. USA (1992), 89:5321-5325.

Methods of optimizing hybridization conditions are well known in the art (see, e.g., Tijssen, (1993), supra). To create competitive hybridization conditions, the array may be contacted simultaneously with differentially labelled nucleic acid fragments of the test sample and the reference sample. This may be done by, for example, mixing the labelled test sample and the labelled reference sample together to form a hybridization mixture, and contacting the array with the mixture.

The specificity of hybridization may be enhanced by inhibiting repetitive sequences. In some embodiments, repetitive sequences (e.g., Alu sequences, L1 sequences, satellite sequences, MRE sequences, simple homo-nucleotide tracts, and/or simple oligonucleotide tracts) present in the nucleic acids of the test sample, reference sample and/or probes are either removed, or their hybridization capacity is disabled. Removing repetitive sequences or disabling their hybridization capacity can be accomplished using any of a variety of well-known methods. These methods include, but are not limited to, removing repetitive sequences by hybridization to specific nucleic acid sequences immobilized to a solid support (see, e.g., Brison et al., Mol. Cell. Biol. (1982), 2: 578-587); suppressing the production of repetitive sequences by PCR amplification using adequately designed PCR primers; inhibiting the hybridization capacity of highly repeated sequences by self-reassociation (see, e.g., Britten et al., Methods of Enzymology (1974), 29: 363-418); or removing repetitive sequences using hydroxyapatite which is commercially available from a number of sources including, for example, Bio-Rad Laboratories, Richmond, Va. In some embodiments, the hybridization capacity of highly repeated sequences in a test sample and/or in a reference sample is competitively inhibited by including, in the hybridization mixture, unlabelled blocking nucleic acids. The unlabelled blocking nucleic acids are therefore mixed with the hybridization mixture, and thus with a test sample and a reference sample, before the mixture is contacted with an array. The unlabelled blocking nucleic acids act as a competitor for the highly repeated sequences and bind to them before the hybridization mixture is contacted with an array. Therefore, the unlabelled blocking nucleic acids prevent labelled repetitive sequences from binding to any highly repetitive sequences of the nucleic acid probes, thus decreasing the amount of background signal present in a given hybridization. In some embodiments, the unlabelled blocking nucleic acids are Human Cot-1 DNA. Human Cot-1 DNA is commercially available from a number of sources including, for example, Gibco/BRL Life Technologies (Gaithersburg, Md.).

Once hybridization is complete, the ratio of the signal intensity of the test sample as compared to the signal intensity of the reference sample is calculated. This calculation quantifies the amount of copy number aberrations present in the genomic DNA of the test sample, if any. In some embodiments, this calculation is carried out quantitatively or semi-quantitatively. In several aspects, it is not necessary to determine the exact copy number aberrations present in the genomic loci tested, as detection of an aberration, i.e. a gain or loss of genetic material, from the copy number in normal, non-cancerous genomic DNA is indicative of the presence of a disease state and is thus sufficient. Therefore, in several embodiments the quantification of the amount of copy number aberrations present in the genomic DNA of a test sample comprises an estimation of the copy number aberrations, as a semi-quantitative or relative measure usually suffices to predict the presence of a disease state and thus prospectively direct the determination of therapy for a subject.

Quantitative techniques may be used to determine the copy number aberrations per cell present in a test sample. Several quantitative and semi-quantitative techniques to determine copy number aberrations exist including, for example, semi-quantitative PCR analysis or quantitative real-time PCR. The Polymerase Chain Reaction (PCR) per se is not a quantitative technique, however PCR-based methods have been developed that are quantitative or semi-quantitative in that they give a reasonable estimate of original copy numbers, within certain limits. Examples of such PCR techniques include, for example, quantitative PCR and quantitative real-time PCR (also known as RT-PCR, RQ-PCR, QRT-PCR or RTQ-PCR). In addition, many techniques exist that give estimates of relative copy numbers, as calculated relative to a reference. Such techniques include many array-based techniques. Absolute copy number estimates may be obtained by in situ hybridization techniques such as, for example, fluorescence in situ hybridization or chromogenic in situ hybridization.

Fluorescence in situ hybridization permits the analysis of copy numbers of individual genomic locations and can be used to study copy numbers of individual genetic loci or particular regions on a chromosome (see, e.g., Pinkel et al., Proc. Natl. Acad. Sci. U.S.A. (1988), 85, 9138-42). Comparative genomic hybridization can also be used to probe for copy number changes of chromosomal regions (see, e.g., Kallioniemi et al., Science (1992), 258: 818-21; and Houldsworth et al., Am. J. Pathol. (1994), 145: 1253-60).

Copy numbers of genomic locations may also be determined using quantitative PCR techniques such as real-time PCR (see, e.g., Suzuki et al., Cancer Res. (2000), 60:5405-9). For example, quantitative microsatellite analysis can be performed for rapid measurement of relative DNA sequence copy numbers. In quantitative microsatellite analysis, the copy numbers of a test sample relative to a reference sample is assessed using quantitative, real-time PCR amplification of loci carrying simple sequence repeats. Simple sequence repeats are used because of the large numbers that have been precisely mapped in numerous organisms. Exemplary protocols for quantitative PCR are provided in Innis et al., PCR Protocols, A Guide to Methods and Applications (1990), Academic Press, Inc. N.Y. Semi-quantitative techniques that may be used to determine specific DNA copy numbers include, for example, multiplex ligation-dependent probe amplification (see, e.g., Schouten et al. Nucleic Acids Res. (2002), 30(12):e57; and Sellner et al., Human Mutation (2004), 23(5):413-419) and multiplex amplification and probe hybridization (see, e.g., Sellner et al. (2004), supra).

### BRCA2 Array Comparative Genomic Hybridization

In various aspects, the present disclosure relates to the use of a BRCA2 aCGH classifier capable of identifying BRCA2-associated tumors. In various aspects, a BRCA2 aCGH classifier capable of identifying BRCA2-associated tumors is set forth on a BRCA2 array, as described herein.

Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 4p13-12, 13q12.2-21.1, 13q31.3-33.1, 14q23.2-32.33, 16q12.1-21, 17q11.1-12 and 17q21.2-21.31. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 6p25.3-11.1, 6q12-13 and 13q31.3-33.1. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 10q22.3-26.13, 13q12.2-21.1 and 14q23.2-32.33. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in the genomic locus 16p12.3-11.2. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 2q36.3-37.1, 4p13-12, 16q12.1-21, 17q11.1-12 and 17q21.2-21.31. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci set forth in FIG. 1A. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci set forth in FIG. 1B. In some embodiments, a BRCA2 aCGH classifier, which in some embodiments is present in an array as described herein, is capable of detecting genomic copy number variations at a number of the above-listed genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, a BRCA2 aCGH classifier, which in some embodiments is present in an array as described herein, is capable of detecting genomic copy number variations at a number of the above-listed genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2.

Using the methods described above, in various aspects, a BRCA2 aCGH classifier, which in some embodiments is present in an array as described herein, is capable of detecting genomic copy number variations in a test sample using at least one, or a plurality, of probes that independently hybridize to at least one, or a plurality, of the genomic loci set forth in FIG. 1A. Using the methods described above, in various aspects, a BRCA2 aCGH classifier, which in some embodiments is present in an array as described herein, is capable of detecting genomic copy number variations in a test sample using at least one, or a plurality, of probes that independently hybridize to at least one, or a plurality, of the genomic loci set forth in FIG. 1B. Using the methods described above, in various aspects, a BRCA2 aCGH classifier, which in some embodiments is present in an array as described herein, is capable of detecting genomic copy number variations in a test sample, as compared to a reference sample, using at least one, or a plurality, of the distinct BAC clones set forth in FIG. 2. In some embodiments, a BRCA2 aCGH classifier, which in some embodiments is present in an array as described herein, capable of detecting genomic copy number variations in a test sample comprises all 704 of the BAC clones set forth in FIG. 2. In some embodiments, a BRCA2 aCGH classifier, which in some embodiments is present in an array as described herein, capable of detecting genomic copy number variations in a test sample comprises a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, a BRCA2 aCGH classifier, which in some embodiments is present in an array as described herein, capable of detecting genomic copy number variations in a test sample comprises a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

### Therapeutic Uses

The present disclosure sets forth BRCA2 classifiers, which in some embodiments are present in one or more arrays as described herein, suitable for use in methods for distinguishing BRCA2-associated tumours from sporadic tumours. In various aspects, the BRCA2 classifiers can be used to distinguish between a cell sample from a BRCA2-associated tumor and a cell sample from a sporadic tumor. Using the methods described above, in various aspects, the BRCA2 classifiers are capable of determining whether an individual subject has a BRCA2-associated tumor. Using the methods described above, in various aspects, the BRCA2 classifiers are capable of determining whether an individual subject has a sporadic tumor. The BRCA2 classifiers are therefore capable of distinguishing between BRCA2-associated tumors and sporadic tumors.

The BRCA2 classifiers can be used to evaluate somatic genetic changes in tumors to give additional information about the involvement of BRCA2 in tumorigenesis. The BRCA2 classifiers are capable of identifying BRCA2-associated tumors based on their genomic signature. As shown in the Examples, in some embodiments the BRCA2 classifiers are able to classify BRCA2-mutated tumors with a sensitivity of about 89% and a specificity of about 84%. The BRCA2 classifiers can thus be used as pre-selection tools, to prospectively detect subjects with a high risk of carrying a BRCA2 mutation. Additionally, the BRCA2 classifiers can be used as tests to identify breast cancer patients having BRCA2-associated tumors.

As shown in the Examples, the BRCA2 classifiers can be used to investigate the chromosomal aberrations of BRCA2-mutated tumors to identify their molecular signature. In some embodiments, the BRCA2 classifiers can be used to distinguish BRCA2-associated tumors from sporadic tumors with about 86.5% accuracy. The BRCA2 classifiers can therefore be used to give additional indications about the involvement of BRCA2 in tumorigenesis of tumors where the role of BRCA2 is still unclear (for example, in tumors having an unclassified variant mutation) or in tumors in which no mutation has yet been found but where a hereditary factor is suspected.

The BRCA2 classifiers can also be used to diagnose phenotypes relating to BRCA2-associated tumors in HBOC patient families that otherwise test negative for BRCA2-related mutations using tests and/or screens currently available. As shown in the Examples, when the BRCA2 classifiers were used to test a pool of HBOC diagnosed cases, several presented a positive BRCA2-like profile, indicating that the BRCA2 classifiers were able to detect the involvement of BRCA2, whereas the tests used to make the original diagnoses could not. Additionally, in the same pool of HBOC diagnosed cases tested with the BRCA2 classifiers, a few cases displayed indications for BRCA2-deficiency, indicating that BRCA2 might be involved in these tumors. The BRCA2 classifiers are thus more sensitive and capable of detecting a BRCA2-like profile in tumors than current tests and/or diagnostics. The BRCA2 profiles can be used in addition to known tests and/or diagnostics, to improve results, or in lieu of such tests and diagnostics as an accurate test for BRCA2-related tumors in and of themselves.

Additionally, the BRCA2 classifiers can be used to identify and diagnose sporadic tumors having a BRCA2 profile, as the BRCA2 profile is, in fact, a phenotype of BRCA2 dysfunction. As shown in the Examples, when used in a clinical setting, the BRCA2 classifiers can be used to detect the presence of a BRCA2 profile in triple negative, basal-like sporadic tumors. Additionally, the BRCA2 classifiers can be used to detect the presence of a BRCA2 profile in estrogen receptor positive luminal sporadic tumors.

In further aspects, the present disclosure relates to kits for use in the diagnostic applications described above. The kits can comprise any or all of the reagents to perform the methods described herein. The kits can comprise one or more of the BRCA2 classifiers, which in some embodiments are present in one or more arrays, as described herein. In the diagnostic applications such kits may include any or all of the following: assay reagents, buffers, nucleic acids such as hybridization probes and/or primers that specifically bind to at least one of the genomic locations described herein, as well as arrays comprising such nucleic acids. In addition, the kits may include instructional materials containing directions (i.e., protocols) for the practice of the methods of this disclosure. While the instructional materials typically comprise written or printed materials they are not limited to such. Any medium capable of storing such instructions and communicating them to an end user is contemplated by this disclosure. Such media include, but are not limited to electronic storage media (e.g., magnetic discs, tapes, cartridges, chips), optical media (e.g., CD ROM), and the like. Such media may include addresses to internet sites that provide such instructional materials.

### EXAMPLES

The following examples describe in detail certain embodiments of the BRCA2 arrays and the BRCA2 aCGH classifiers. It will be apparent to those skilled in the art that many modifications, both to materials and methods, may be practiced without departing from the scope of the disclosure.

### Example 1

### Prediction of BRCA2 Association in Hereditary Breast Carcinomas with Array-CGH

A BRCA2 classifier (FIG. 2) was built using array-CGH profiles of 28 BRCA2 mutated and 28 sporadic breast tumors. This classifier was validated on an independent group consisting of 19 BRCA2-mutated and 19 sporadic breast tumors. Subsequently, 89 breast tumors from suspected hereditary breast (and ovarian) cancer (HBOC) families in which either no BRCA1/2 mutation or an unclassified variant (UV) had been found by standard diagnostics were tested with this classifier.

The classifier showed a sensitivity of about 89% and specificity of about 84%. Of the 89 HBOC cases, 17 presented a BRCA2-like profile. In three of these cases, additional indications for BRCA2 deficiency were found. Chromosomal aberrations that were specific for BRCA2-mutated tumors included loss on chromosome arm 13q and 14q, and gain on 17q.

Use of the classifier to classify breast tumors can be applied as a clinical test, for example for use in addition to current diagnostics, to help clinicians in decision making related to treatment options and in classifying sequence variants of unknown significance.

Individuals that inherit a germline mutation in BRCA2 will have an increased lifetime risk of developing breast or ovarian cancer. Several recent publications have reviewed the importance of identifying BRCA2 mutation carriers for optimal therapy and non-carriers for chemoprevention (Foulkes, W D. BRCA1 and BRCA2: chemosensitivity, treatment outcomes and prognosis. Fam Cancer 2006; 5(2):13542; and Rubinstein W S. Hereditary breast cancer: pathobiology, clinical translation, and potential for targeted cancer therapeutics. Fam Cancer 2008; 7(1):839). Successful mutation identification impacts not only on the patient but also on the family members, since it allows for presymptomatic mutation screening. The current strategy to identify mutation carriers is first to select those patients eligible for mutation screening based on prediction models that use age and family history (Antoniou A C, Hardy R, Walker L, Evans D G, Shenton A, Eeles R, et al. Predicting the likelihood of carrying a BRCA1 or BRCA2 mutation: validation of BOADICEA, BRCAPRO, IBIS, Myriad and the Manchester scoring system using data from UK genetics clinics. J Med Genet. 2008 July; 45(7):42531). Subsequently, the mutation screening is performed by, for example, sequencing of gene fragments in germline DNA, Protein Truncation Test (PTT) and Denaturing Gradient Gel Electrophoresis (DGGE) (Hogervorst F B, Cornelis R S, Bout M, van V M, Oosterwijk J C, Olmer R, et al. Rapid detection of BRCA1 mutations by the protein truncation test. Nat Genet. 1995 June; 10(2):20812; and van der Hout A H, van den Ouweland A M, van der Luijt R B, Gille H J, Bodmer D, Bruggenwirth H, et al. A DGGE system for comprehensive mutation screening of BRCA1 and BRCA2: application in a Dutch cancer clinic setting. Hum Mutat 2006 July; 27(7):65466). However, it still remains unclear to what extent mutation carriers are accurately identified with the current diagnostic tools, since many families with a history for breast cancer remain unexplained. It is known that mutation prediction models do not perform perfectly and are highly dependent on the number of family members, from which information is available (Antoniou A C, Hardy R, Walker L, Evans D G, Shenton A, Eeles R, et al. Predicting the likelihood of carrying a BRCA1 or BRCA2 mutation: validation of BOADICEA, BRCAPRO, IBIS, Myriad and the Manchester scoring system using data from UK genetics clinics. J Med Genet. 2008 July; 45(7):42531; and Kang H H, Williams R, Leary J, Ringland C, Kirk J, Ward R. Evaluation of models to predict BRCA germline mutations. Br J Cancer 2006 Oct. 9; 95(7):91420). Another clinically difficult situation is the identification of a UV in coding or non-coding regions in the BRCA2 gene. The pathogenicity of such a nucleotide variant is often uncertain as the effect on the protein function is unknown. Therefore, its clinical significance also remains unclear. Although functional assays exist for the proteins produced by mutated BRCA2 genes, these are laborious, difficult to interpret in clinical terms, limited to only a number of protein functionalities, and not yet routinely applicable in a diagnostic setting. Therefore, the profiling of somatic genetic changes in breast tumors as described herein provides a new strategy that can give additional information about the involvement of BRCA2 in tumorigenesis.

In this Example, array-CGH was used to investigate the copy number changes of DNA sequences extracted from formalin fixed, paraffin embedded (FFPE) tissue, which is readily available in pathology archives and therefore very suitable for diagnostic purposes.

Materials and Methods

Patient Selection

Three breast cancer groups were used: 1) 47 breast carcinomas from women with a confirmed pathogenic BRCA2 germline mutation, mean age at diagnosis of 46 years (age range: 26-86); 2) 47 sporadic breast tumors from women with unknown BRCA2 status, mean age at diagnosis of 45 years (age range: 29-78), no known family history for breast cancer and matched to the tumor group mentioned above; 3) 89 tumors from women that were eligible according to the HBOC criteria for, and subjected to, routine diagnostic testing but were found to be negative for pathogenic BRCA2 mutations, or were diagnosed to carry an UV in BRCA2 (see Table 1), mean age at diagnosis of 47 years (age range: 27-75).

TABLE 1
Unclassified variants classified with the aCGH classifiers.

| Case | Gene | UV | Type | Effect | Classification |
|---|---|---|---|---|---|
| PFT2946 | BRCA2 | c.6842-20T > A | Intronic | Different splice | Sporadic-like |
| (2x) | | | variant | prediction programs: | |
| | | | | no effect | |
| PFT5737 | BRCA2 | c.9502-12T > G | Intronic | Loss of splice acceptor | BRCA2-like |
| | | | variant | site, deletion of exon | |
| | | | | 26 | |
| PFT6270 | BRCA2 | c.1395A > C | Silent coding | Very likely no effect | Sporadic-like |
| | | | variant | | |

Listed are the Type and the Effect of the UVs. aCGH profiles were classified with the BRCA2 classifier shown in FIG. 2 (Classification).
Case PFT2946 was diagnosed with two primary tumors.

All sample material was formalin fixed, paraffin embedded (FFPE) archival tissue; DNA was extracted and the quality tested as described before (Joosse S A, van Beers E H, Tielen I H, Horlings H, Peterse J L, Hoogerbrugge N, et al. Prediction of BRCA1 association in hereditary nonBRCA1/2 breast carcinomas with arrayCGH. Breast Cancer Res Treat 2008 Aug. 14; and van Beers E H, Joosse S A, Ligtenberg M J, Fles R, Hogervorst F B, Verhoef S, et al. A multiplex PCR predictor for aCGH success of FFPE samples. Br J Cancer 2006 Jan. 30; 94(2):3337). The immunohistological characteristics of each tumor group are listed in Table 2, individual sample characteristics are reported in Joosse et al., Prediction of BRCA-2 association in hereditary breast carcinomas using array-CGH, Breast Cancer Res Treat. 2010 Jul. 8. PubMed PMID: 20614180. All experiments involving human tissues were conducted with the permission of the institute's medical ethical advisory board. CGH profiles of all BRCA1 mutated tumors described in this Example as well as 37 cases of the HBOC group were from a previous study (Joosse S A, van Beers E H, Tielen I H, Horlings H, Peterse J L, Hoogerbrugge N, et al. Prediction of BRCA1 association in hereditary nonBRCA1/2 breast carcinomas with arrayCGH. Breast Cancer Res Treat 2008 Aug. 14).

TABLE 2
Tumor group characteristics. Immunohistological characteristics of the
BRCA2-mutated and sporadic tumor groups, listed in percentages. Here
intermediate stainings were called positive.

| | BRCA2-mutated | Sporadic | Training B2 | Training Sp |
|---|---|---|---|---|
| | (n = 47) | (n = 47) | (n = 28) | (n = 28) |
| Grade | | | | |
| I | 15 (n = 7) | 15 (n = 7) | 18 (n = 5) | 14 (n = 4) |
| II | 36 (n = 17) | 32 (n = 15) | 29 (n = 8) | 29 (n = 8) |
| III | 49 (n = 23) | 53 (n = 25) | 54 (n = 15) | 57 (n = 16) |
| ER | | | | |
| + | 83 (n = 39) | 83 (n = 39) | 82 (n = 23) | 79 (n = 22) |
| − | 17 (n = 8) | 17 (n = 8) | 18 (n = 5) | 21 (n = 6) |
| PR | | | | |
| + | 45 (n = 21) | 57 (n = 27) | 54 (n = 15) | 57 (n = 16) |
| − | 55 (n = 26) | 43 (n = 20) | 46 (n = 13) | 43 (n = 12) |
| HER2 | | | | |
| + | 13 (n = 6) | 19 (n = 9) | 18 (n = 5) | 21 (n = 6) |
| − | 87 (n = 41) | 81 (n = 38) | 82 (n = 23) | 79 (n = 22) |
| p53 | | | | |
| + | 43 (n = 20) | 36 (n = 17) | 86 (n = 24) | 82 (n = 23) |
| − | 57 (n = 27) | 64 (n = 30) | 14 (n = 4) | 18 (n = 5) |

Values are expressed as percentage.
Training B2 = Classifier training group BRCA2-mutated,
Training Sp = Classifier training group Sporadic.

Immunohistochemistry (IHC)

Presence of ER, PR, HER2/neu, and p53 were determined by immunohistochemistry staining using the following antibodies: estrogen receptor AB14 clone 1D5+6F11, titer 1:50 (Neomarkers); progesterone receptor clone PR1, titer 1:400 (Immunologic); cerbB2 clone SP3, titer 1:25 (Neomarkers); and TP53 clone D07, titer 1:8000 (DAKO), respectively. If ≧70% of the tumor cells expressed ER, PR, or p53, the tumor was scored as positive (+) for the corresponding staining. If g 0% of the cells were stained, the tumor was scored as negative (−). Those cases that stained between 10% and 70% of the tumor cells were scored as intermediate (+/−) for the corresponding staining. HER2/neu staining was scored positive when a 3+ staining was observed, otherwise it was scored as negative.

Array-CGH

ULS-Cy5 labeled tumor DNA and ULS-Cy3 labeled female reference DNA were cohybridized for 72 hours on a microarray containing 3.5 k BAC/PAC derived DNA segments covering the whole genome with an average spacing of 1 MB. Sample preparation, labeling, BAC arrays preparation, and array processing were done as previously described (Joosse S A, van Beers E H, Nederlof P M. Automated arrayCGH optimized for archival formalin fixed, paraffin embedded tumor material. BMC Cancer 2007; 7:43). Microarray data have been deposited in NCBIs Gene Expression Omnibus and are accessible through GEO Series accession number GPL4560.

Detection and Quantification of Aberrations

To analyze the chromosomal aberrations, the breakpoint locations and estimated copy number level were determined using the CGH segmentation algorithm described by Picard et al. (Picard F, Robin S, Lavielle M, Vaisse C, Daudin J J. A statistical approach for array CGH data analysis. BMC Bioinformatics 2005; 6:27), further referred to as the ‘segmentation data’. Since tumor percentage and heterogeneity both influence the dynamic range of an aCGH profile, a profile dependent cutoff was used for each experiment to call gains and losses instead of an arbitrary chosen cutoff on all samples. The cutoff for every single profile was two times the standard deviation of the profile segmentation data excluding singletons and high level amplification (log 2ratio>1.0) that would otherwise influence the standard deviation excessively. The average of the thresholds was 0.11 (total range: 0.06-0.18). These cutoffs were applied to the segmentation data to calculate the number of aberrations present in a CGH profile. The association of the frequency of a clone being ‘gained’, ‘lost’, or ‘unchanged’ across the different tumors groups was calculated by employing a 3×2 Fisher's exact (FE) test.

Classifier

The classifier used in this Example is shown in FIG. 2. The approach of Dobbin and Simon (Dobbin K K, Zhao Y, Simon R M. How Large a Training Set is Needed to Develop a Classifier for Microarray Data? Clin Cancer Res 2008 Jan. 1; 14(1):10814) was used to calculate the required sample size using a standardized fold change of 1.3. For an error tolerance of <0.10, more than 23 samples of each class were needed. The Shrunken Centroids (SC) algorithm (Tibshirani R, Hastie T, Narasimhan B, Chu G. Diagnosis of multiple cancer types by shrunken centroids of gene expression. Proc Natl Acad Sci USA 2002 May 14; 99(10):656772) was used to construct the classifier used for array-CGH based on the segmentation data, to eliminate technical noise. To train the classifier, a fraction of 0.6 (n=28) of each group was randomly selected. The classifier was validated with the remaining fraction of the samples (n=19) of each group.

As a result, the classification algorithm predicts the classes' likelihoods for each sample. Since the sum of the two likelihoods is always “1”, the highest class probability (>0.5) is described.

Additional Screening for BRCA2 Defects

To identify defects in the BRCA2 gene that could have been missed by standard diagnostics, the following additional tests were performed: BRCA2 exon deletion/duplication MLPA, according to the manufacturer's protocol (MRCHolland, The Netherlands, MLPA kit P090); sequencing of mRNA extracted from lymphocytes to determine bi/monoallelic expression of BRCA2 in the patient along regions containing a single nucleotide polymorphism (SNP), using standard protocols; loss of heterozygosity (LOH) of the BRCA2 locus in tumor DNA using the markers D13S171, D13S260, D13S267, and D13S289; and methylation of the BRCA2 promoter using methylation MLPA according to the manufacturer's protocol (MRCHolland, The Netherlands, MSMLPA kit ME001B).

Results

Array CGH profiles of 47 BRCA2 mutated, 47 sporadic, and 89 nonBRCA1/2 mutated breast tumors from patients from hereditary breast (and ovarian) cancer families (HBOC) were obtained. The chromosomal aberrations and their locations, the differences between tumor groups, and the discriminating power of a class predictor based on array CGH results are described below.

Chromosomal Aberrations: BRCA2 vs. Sporadic

Most aberrations found in the BRCA2-mutated tumor group were also present in the sporadic tumor group in similar frequencies. Genome wide frequency of gains and losses in the BRCA2-mutated and the sporadic control groups were as previously shown (see FIG. 1, Joosse et al., Prediction of BRCA-2 association in hereditary breast carcinomas using array-CGH, Breast Cancer Res Treat. 2010 Jul. 8. PubMed PMID: 20614180). Based on such frequencies, Fisher's exact test was employed to determine which aberrations are significantly different between the two groups. By this, 7 chromosomal regions were identified as BRCA2-related. These regions consisted of at least 5 adjacent BAC clones with a p-value of <0.01 (Table 3). Based on the calculated breakpoints using CGH-segmentation (Picard F, Robin S, Lavielle M, Vaisse C, Daudin J J. A statistical approach for array CGH data analysis. BMC Bioinformatics 2005; 6:27), the number of aberrations in both tumor groups were counted. BRCA2-mutated tumors showed on average 28.7 aberrations (range: 14-51) and sporadic tumors showed a comparable average of 27.7 aberrations (range: 13-45), which was not significantly different (p=0.51, t-test).

TABLE 3
Significant chromosomal aberrations. Seven chromosomal regions were present in
significantly different frequencies between the mutated and sporadic breast tumors
calculated by Fisher's exact (FE) test.

| | | BRCA2-Mutated | | Sporadic | | |
|---|---|---|---|---|---|---|
| Chr | Cytoband | Gain (%) | Loss (%) | Gain (%) | Loss (%) | FE test (p value) |
| 13 | q12-q14 | 4 | 78 | 5 | 44 | 2.1E−3 |
| 14 | q23.2-q32.2 | 2 | 62 | 9 | 22 | 5.7E−4 |
| 16 | p13 | 14 | 2 | 41 | 3 | 3.7E−3 |
| 16 | q12 | 10 | 18 | 5 | 51 | 3.0E−3 |
| 17 | q11-q21.31 | 36 | 8 | 15 | 32 | 6.2E−3 |

Five chromosomal regions (Chr.) were present in significantly different frequencies between the BRCA2-mutated and sporadic breast tumors calculated by Fisher's exact test. Given are the average percentages of gain and loss in both tumor groups of the corresponding chromosomal region and p value (FE test).

Chromosomal Aberrations: BRCA2 vs. BRCA1

Comparison of the CGH profiles of the BRCA2-mutated tumors analyzed in this Example with BRCA1-mutated tumors previously characterized reveals many different aberrations, as shown by the results of Fisher's exact test (see FIG. 1, Joosse et al., Prediction of BRCA-2 association in hereditary breast carcinomas using array-CGH, Breast Cancer Res Treat. 2010 Jul. 8. PubMed PMID: 20614180). The number of aberrations differed significantly between these groups (p=1.25*10-7, t-test), as BRCA2-mutated tumors showed on average 28.7 aberrations, BRCA1-mutated tumors showed on average 36.7 aberrations (range: 22-49).

BRCA2 Class Predictor

Twenty-eight CGH profiles of the BRCA2-mutated tumor group and 28 from the sporadic tumor group were randomly selected to train a BRCA2/sporadic breast tumor classifier. Employing leave-one-out cross-validation (LOOCV), Δ=0.4 led to the lowest misclassification rate. Using these 56 profiles, 704 features were selected as discriminatory by the SC algorithm (FIG. 2). These features were most abundant along the chromosomal regions 10q23.1-q26.13, 11q13.2-q14.2, 11q23.1-q25, 13q12.2-q21.1, 13q31.3-q33.2, 14q23.2-q32.33, 16p12.1-q21, 17p12-q21.31, 22q11.23-22q13.1, and Xp22.33-p11.3. When reclassifying the training samples, one sample of the BRCA2-mutated tumors and one sample of the sporadic tumors classified to the other class (misclassification of 4%).

The remaining profiles of 38 samples were used to validate the classifier. FIG. 2 shows the distribution of the classification scores for the training as well as for the validation sets. During validation, 17 of 19 BRCA2-mutated tumors and 16 of 19 sporadic tumors were correctly classified. Based on these numbers, the sensitivity was determined to be about 89% and the specificity about 84%; the positive (PPP) and negative predictive power (NPP) were about 85% and about 89%, respectively.

To further evaluate the performance of the chromosomal regions that were selected for discriminating BRCA2-mutated and sporadic breast tumors, hierarchical cluster analyses (complete linkage, Pearson correlation) was performed on the segmentation data of all the samples based on these regions only. FIG. 3 of Joosse et al. (Breast Cancer Res Treat. 2010 Jul. 8. PubMed PMID: 20614180) depict the result of the cluster analyses and shows that the samples are divided into three large clusters. IHC data of each sample are displayed along the cluster tree to explore whether samples of both groups residing in one cluster would share the same IHC phenotype, but this was not the case. Two branches contain all except two of the sporadic cases and one large cluster contains all but two of the BRCA2-mutated cases. These results indicate that the features selected for classification do indeed have discriminatory power, regardless of the algorithm and IHC phenotype.

Clinical Application of the BRCA Classifiers

To evaluate the BRCA2 classifier in a clinical setting, 89 breast cancer samples from HBOC patients were analyzed. These samples were also classified using a BRCA1 classifier previously described (Joosse S A, van Beers E H, Tielen I H, Horlings H, Peterse J L, Hoogerbrugge N, et al. Prediction of BRCA1 association in hereditary nonBRCA1/2 breast carcinomas with arrayCGH. Breast Cancer Res Treat 2008 Aug. 14) to investigate the performance of both the classifiers in respect to each other. Using the BRCA2 classifier, seventeen cases (19%) classified as BRCA2-like with a BRCA2 class probability >0.5, 13 of them with a probability >0.8; the remaining 72 cases (81%) were classified as sporadic-like. One of the BRCA2-like cases carried the BRCA2 UV c.950212T>G. When the same 89 cases were tested with the BRCA1 classifier, eleven were diagnosed as BRCA1-like. Of these eleven cases, one carried the BRCA1 UV c.819C>G and two were also classified as BRCA2-like. All 17 BRCA2-like cases, 11 BRCA1-like cases and the cases carrying an UV were studied in more detail using additional molecular tests to identify possible missed BRCA1/2 associated cases, described below.

Unclassified Variants

Sequence analysis had previously revealed unclassified variants in BRCA2 in three of the samples tested (Table 1). To investigate the pathogenicity of these UVs, the mRNA was analyzed by cDNA sequencing. This revealed that BRCA2 UV c.950212T>G led to the deletion of exon 26, indicating that this unclassified variant is pathogenic and results in nonfunctional proteins. This is in correlation with the CGH profiles of these cases that were classified as BRCA2-like. For the remaining two BRCA2 UV cases, no indications were found for pathogenicity, which is in concordance with the classifier's prediction for the samples, which was sporadic-like.

Mutation Analysis

The entire BRCA2 gene was investigated for whole exon deletions or duplications using the P090 MLPA kit (MRCHolland). None of the investigated cases showed such aberration.

Loss of Heterozygosity (LOH)

LOH was investigated at 4 microsatellite markers flanking the BRCA2 gene in the BRCA2-like cases. Most of the samples (80%) showed LOH at least one informative (i.e. heterozygous) marker.

Promoter Methylation

Methylation of the BRCA2 promoter was investigated using the ME001 methylation MLPA kit (MRCHolland). None of the HBOC cases were found to be positive for methylation of the BRCA2 promoter.

Allele-Specific Expression

It was determined whether both or just one allele of BRCA2 was expressed in the patients' blood. In various embodiments, expression of only one allele could indicate a defective gene by a germline mutation. mRNA regions containing a SNP that was detected by standard diagnostics were sequenced to identify the ratio of expressed alleles. Eight of the BRCA2-like cases were found to be heterozygous for a coding SNP. Only a single case appeared to express one allele of BRCA2, suggesting that this patient carries a defective copy of BRCA2 in her germline DNA.

Discussion

The chromosomal aberrations of BRCA2-mutated breast tumors were investigated to identify their molecular signature and found that, by using array-CGH, these tumors can be distinguished from sporadic tumors with about 86.5% accuracy. This signature can be used to give additional indications about the involvement of BRCA2 in tumorigenesis of breast tumors where the role of BRCA2 is still unclear (i.e. an UV) or in tumors in which no mutation has yet been found, but where a hereditary factor is suspected. Therefore, via use of the classifier disclosed herein, classification suggesting the involvement of BRCA2 could lead to extended diagnostics, help clinicians in decision making, and lead to adjusted therapy that exploits BRCA2 deficiency.

Several attempts have been made to identify a molecular BRCA2 signature using gene expression patterns or CGH to discriminate BRCA2-mutated tumors from BRCA1-mutated and sporadic tumors (Jonsson G, Naylor T L, VallonChristersson J, Staaf J, Huang J, Ward M R, et al. Distinct genomic profiles in hereditary breast tumors identified by array based comparative genomic hybridization. Cancer Res 2005 Sep. 1; 65(17):761221; van Beers E H, van W T, Wessels L F, Li Y, Oldenburg R A, Devilee P, et al. Comparative genomic hybridization profiles in human BRCA1 and BRCA2 breast tumors highlight differential sets of genomic aberrations. Cancer Res 2005 Feb. 1; 65(3):8227; Hedenfalk I, Duggan D, Chen Y, Radmacher M, Bittner M, Simon R, et al. Gene expression profiles in hereditary breast cancer. N Engl J Med 2001 Feb. 22; 344(8):53948; and Melchor L, Honrado E, Garcia M J, Alvarez S, Palacios J, Osorio A, et al. Distinct genomic aberration patterns are found in familial breast cancer associated with different immunohistochemical subtypes. Oncogene 2008 May 15; 27(22):316575). BRCA2-mutated tumors are frequently ER positive and grade II, while BRCA1-mutated tumors are in general ER negative and grade II (Joosse S A, van Beers E H, Tielen I H, Horlings H, Peterse J L, Hoogerbrugge N, et al. Prediction of BRCA1 association in hereditary nonBRCA1/2 breast carcinomas with arrayCGH. Breast Cancer Res Treat 2008 Aug. 14; and Lakhani S R, van de Vijver M J, Jacquemier J, Anderson T J, Osin P P, McGuffog L, et al. The pathology of familial breast cancer: predictive value of immunohistochemical markers estrogen receptor, progesterone receptor, HER2, and p53 in patients with mutations in BRCA1 and BRCA2. J Clin Oncol 2002 May 1; 20(9):23108). Large parts of the molecular signatures that have been found to discriminate between BRCA1- and BRCA2-mutated breast tumors in previous published studies are also found in sporadic breast tumors that are compared based on ER status or histological grade (Bergamaschi A, Kim Y H, Wang P, Sorlie T, HernandezBoussard T, Lonning P E, et al. Distinct patterns of DNA copy number alteration are associated with different clinicopathological features and gene expression subtypes of breast cancer. Genes Chromosomes Cancer 2006 November; 45(11):103340; and Melchor L, Honrado E, Huang J, Alvarez S, Naylor T L, Garcia M J, et al. Estrogen receptor status could modulate the genomic pattern in familial and sporadic breast cancer. Clin Cancer Res 2007 Dec. 15; 13(24):730513). Comparison of the aCGH profiles of the BRCA2-mutated tumors described herein with the profiles of BRCA1-mutated tumors in previous reports shows many differences of which also many can be related to ER status and histological grade.

Although BRCA2 is specifically involved in homologous recombination, both the BRCA2-associated and the sporadic tumor group showed a comparable average number of aberrations (29 and 28 respectively). Several differences between the groups were found based on the frequency of aberrations. These results indicate that loss of function of BRCA2 is not related to more genomic aberrations (detectable with array-CGH) but does require specific genomic locations to be gained or lost in tumorigenesis. Loss on chromosome 14q and the absence of loss on chromosome 16q were found to be significantly different between BRCA2-mutated and sporadic tumors.

Using the shrunken centroids algorithm, a classifier with BRCA2-mutated and sporadic tumors was built resulting in about 89% sensitivity and about 84% specificity. In order to evaluate the selected centroids, Pearson correlation was used as a second method to investigate the relationship between the samples. This resulted in a total of 4 out of 94 misclassifications, which is comparable with the results obtained with the shrunken centroids algorithm. This indicates that the genomic regions that were selected for the classification are indeed BRCA2 specific, regardless of the algorithm used. Small subclusters within the sporadic class can be distinguished showing separation based on IHC status. It is notable that are the misclassified BRCA2-mutated samples cluster together with sporadic samples sharing similar ER status, again indicating the association of genomic aberrations with ER status.

Applying the BRCA2 classifier to HBOC cases formally designated as not having either a BRCA1 or a BRCA2 mutation, and to BRCA1 and/or BRCA2 UV carriers, 17 tumors were found to be BRCA2-like. By analyzing germline and tumor DNA from the BRCA2-like cases, as well as mRNA extracted from lymphocytes, indications for dysfunctional BRCA2 were found in three cases. The first of these cases was found to carry an UV that led to the deletion of exon 26 of BRCA2. The other two cases only expressed one BRCA2 allele investigated in lymphocytes. This suggests the presence of a germline defect in the other allele. Methylation of the BRCA2 promoter was not found, however this is in agreement with reports suggesting that this does not occur frequently in breast cancer (Kontorovich T, Cohen Y, Nir U, Friedman E. Promoter methylation patterns of ATM, ATR, BRCA1, BRCA2 and P53 as putative cancer risk modifiers in Jewish BRCA1/BRCA2 mutation carriers. Breast Cancer Res Treat 2008 Jul. 19; and Dworkin A M, Spearman A D, Tseng S Y, Sweet K, Toland A E. Methylation not a frequent “second hit” in tumors with germline BRCA mutations. Fam Cancer 2009 Apr. 2).

### Conclusion

The classifier disclosed herein, as well as the classification method used in this Example were able to distinguish BRCA2-mutated from sporadic breast tumors based on their chromosomal aberrations with an accuracy of about 86.5%. Applying this classifier to 89 breast tumors from high risk patients either carrying no pathogenic BRCA1 and/or BRCA2 mutation or carrying a BRCA2 UV, 17 BRCA2-like cases were identified, from which indicia of BRCA2 deficiency was found in three cases. The classifier can be used as a tool to identify BRCA2-associated patients. The classifier and related methods can be combined with other existing methods in order identify BRCA2-associated patients.

### Example 2

### Homologous Recombination Deficiency in Breast Cancer and Association with Response to Neo-Adjuvant Chemotherapy

Tumors with homologous recombination deficiency (HRD), such as BRCA2 associated breast cancers, are not able to reliably repair DNA double strand breaks (DSBs), and are highly sensitive to alkylating agents and PARP inhibitors. Markers that may indicate the presence of HRD in patients with HER2-negative breast cancer, scheduled to receive neoadjuvant chemotherapy, have been previously studied. Forty-three triple negative (TN) and 91 estrogen receptor positive (ER+) pre-treatment biopsies from sporadic breast cancer patients were examined. In ER+ tumors, an aCGH “BRCA2-like” pattern and the amplification of the BRCA2 inhibiting gene EMSY were frequently observed (37% and 15% respectively). In addition, EMSY amplification and a “BRCA2-like” pattern rarely occurred together, raising doubts about the assumption that EMSY amplification inactivates BRCA2 and causes HRD.

### Introduction

The breast cancer gene BRCA2 is involved in homologous recombination and tumors of patients carrying germ-line mutations in this gene show HRD. BRCA2 can be inactivated in sporadic cancers as well (Joosse, S. A., van Beers, E. H., Tielen, I. H., et al Prediction of BRCA1-association in hereditary non-BRCA1/2 breast carcinomas with array-CGH, Breast Cancer Res Treat, 2008; and Turner, N., Tutt, A. and Ashworth, A. Hallmarks of ‘BRCAness’ in sporadic cancers, Nat Rev Cancer, 4: 814-819, 2004), a phenomenon sometimes referred to as “BRCA-ness”. Many other genes are involved in homologous recombination, including the Fanconi anemia genes and the BRCA2 inactivating gene EMSY (Hughes-Davies, L., Huntsman, D., Ruas, M., et al EMSY links the BRCA2 pathway to sporadic breast and ovarian cancer, Cell, 115: 523-535, 2003).

It has previously been shown that breast cancers from BRCA1 mutation carrying patients have a characteristic pattern of DNA gains and losses in an array comparative genomic hybridization (aCGH) assay (Wessels, L. F., van Welsem, T., Hart, A. A., Van't Veer, L. J., Reinders, M. J. and Nederlof, P. M. Molecular classification of breast carcinomas by comparative genomic hybridization: a specific somatic genetic profile for BRCA1 tumors, Cancer Res, 62: 7110-7117, 2002). This pattern is also found in a subgroup of hormone receptor-negative sporadic breast cancers that do not contain a BRCA1 mutation.

In this Example, the frequency in which these possibly HRD-associated features occur in untreated patients with breast cancer was prospectively determined.

Patients and Methods

Patients

Pre-treatment biopsies of primary breast tumors from 134 women with HER2 negative breast cancer were collected. All patients had received neoadjuvant treatment at the Netherlands Cancer Institute between 2000 and 2007 as part of two ongoing clinical trials, or were treated off protocol according to the standard arm of one of these studies. Both studies had been approved by the ethical committee and written informed consent was obtained. For eligibility, breast carcinoma with either a primary tumor size of at least 3 cm was required, or the presence of fine needle aspiration (FNA)-proven axillary lymph node metastases. Biopsies were taken using a 14G core needle under ultrasound guidance. After collection, specimens were snap-frozen in liquid nitrogen and stored at −70° C. Each patient had two or three biopsies taken to assure that enough tumor material was available for both diagnosis and further study.

Depending on the particular study, a treatment regimen was assigned to each patient, which consisted of one of the following: 1.) Six courses of dose-dense Doxorubicin/Cyclophosphamide (ddAC); or 2.) Six courses of Capecitabine/Docetaxel (CD); or 3.) Three courses of ddAC followed by three courses CD (or vice versa) if the therapy response was considered unfavorable by MRI evaluation after three courses. For the response analysis, only those patients who started with ddAC (group 1 and group 3) were considered.

Response Evaluation

The response of the primary tumor to chemotherapy was evaluated by contrast-enhanced MRI after 3 courses of chemotherapy, and after surgery by pathologic evaluation of the resection specimen. The primary end point of both studies was termed a “pCR,” which was defined as the complete absence of residual invasive tumor cells seen at microscopy. If only non-invasive tumor (carcinoma in situ) was detected, this was considered a pCR as well. When a small number of scattered tumor cells were seen, the samples were classified as ‘near pCR’ (npCR). Because the aim of this study was to determine if HRD was correlated with a higher sensitivity to chemotherapy, tumors with a npCR were included in the group of complete remission for analytical purposes. Patients with larger amounts of residual tumor left were classified as non-responders (NR).

Array-CGH

Tumor DNA and reference DNA were co-hybridized using two different CyDyes to a microarray containing 3.5 k BAC/PAC derived DNA segments covering the whole genome with an average spacing of 1 MB and processed as described before (Joosse, S. A., van Beers, E. H. and Nederlof, P. M. Automated array-CGH optimized for archival formalin-fixed, paraffin-embedded tumor material, BMC Cancer, 7: 43, 2007). Classification of subtypes was performed using the aCGH BRCA2 classifiers disclosed herein and developed by Joosse et al. (Joosse, S. A., Brandwijk, K. I. M., Devilee, P., et al Prediction of BRCA1- and BRCA2-association in hereditary breast carcinomas with array-CGH, Breast Cancer Res Treat. 2010 Jul. 8. PubMed PMID: 20614180). When the BRCA2 score was 0.50 or higher the tumour was qualified as BRCA2-like (Joosse, S. A., Brandwijk, K. I. M., Devilee, P., et al Prediction of BRCA1- and BRCA2-association in hereditary breast carcinomas with array-CGH, Breast Cancer Res Treat. 2010 Jul. 8. PubMed PMID: 20614180). Under this cut-off a tumour was called sporadic-like. For response analysis, a 0.8 cut-off was also applied.

RT PCR

mRNA isolation and extraction were performed using RNA Bee, according to the manufacturers protocol (Isotex, Friendswood, Tex.). A 5 μm section halfway through the biopsy was stained for Hematoxylin and Eosin and analyzed by a pathologist for tumor cell percentage. Only samples that contained at least 60% tumor cells were included in further analysis. GAPDH and B-actin were measured for normalization purposes and the average of both gene expression values was used.

MLPA

Amplification of EMSY (C11orf30) was determined using a custom MLPA set, containing seven different EMSY probes and nine reference probes (MRC Holland, The Netherlands; X025). This EMSY MLPA set was first validated by an EMSY FISH assay (Dako, Glostrup, Denmark). From the comparison of the EMSY FISH assay and the MLPA, it was determined that an average of the seven probes above 1.5 corresponded to EMSY amplification, as detected by at least 6 copies of the probe at the FISH assay. DNA fragments were analyzed on a 3730 DNA Analyzer (AB, USA). For normalization and analysis the Coffalizer program was used (MRC-Holland, The Netherlands).

Statistical Tests

The Fisher's exact test was used to assess association between the dichotomized HRD characteristics. The Mann-Whitney U test was used to analyze means of variables. All data analyses were performed using SPSS version 15.

Results

Overview of Samples

In the series of patients described in this Example, the frequency of features associated with HRD in pre-treatment biopsies was examined. HER2+ tumors were not investigated. aCGH was used to assess “BRCA-ness”. If the pattern of genomic alterations resembled that of BRCA2-associated tumors, the sample was called BRCA2-like. If no pattern was recognized the tumor was called sporadic-like. A total of 134 tumors were studied, of which 91 were ER+ and 43 were Triple Negative tumors. See table 1 for an overview of the different patients.

TABLE 1
Patient and tumor characteristics

| | | TN | | ER+ | |
|---|---|---|---|---|---|
| Number of patients | | 43 | | 91 | |
| Median age (sd) | | 45 (11.18) | | 50.5 (9.14) | |
| Progesterone receptor | Positive | 0 | 0% | 58 | 64% |
| | Negative | 100 | 100% | 33 | 36% |
| T-stage | T1 | 2 | 5% | 12 | 13% |
| | T2 | 29 | 67% | 51 | 56% |
| | T3 | 11 | 26% | 25 | 28% |
| | T4 | 1 | 2% | 3 | 3% |
| N-stage | Node negative | 28 | 65% | 22 | 24% |
| | Node positive | 15 | 35% | 69 | 76% |
| Initial chemotherapy | AC | 38 | 88% | 81 | 89% |
| | DC | 2 | 5% | 7 | 8% |
| | other | 3 | 7% | 3 | 3% |
| Response | pCR | 15 | 34% | 6 | 7% |
| | npCR | 7 | 16% | 12 | 13% |
| | NR | 19 | 44% | 67 | 74% |
| | unknown | 2 | 5% | 6 | 7% |

AC = doxorubicin, cyclophosphamide;
DC = docetaxel, capecitabine;
(n)pCR = (near) pathological complete remission;
NR = non response

Array CGH was performed in 37 TN and 75 ER+ tumors. The BRCA2-like profile was observed in both TN and ER+ tumors (32% and 37% respectively) (Table 2). The BRCA2 inhibiting gene EMSY was only amplified in ER+ tumors, in this tumor group the frequency was 15%. This initial analysis shows that a BRCA2-like profile occurs in both TN and ER+ tumors. This is in concordance with the fact that tumors in BRCA2 carriers are often ER+ (Chappuis, P. O., Nethercot, V. and Foulkes, W. D. Clinico-pathological characteristics of B, Semin Surg Oncol, 18: 287-295, 2000).

TABLE 2
Summary of HRD characteristics

| | TN (n = 43) | ER+ (n = 91) | p-value |
|---|---|---|---|
| aCGH BRCA2-like | | | |
| B2-like | 12 (32%) | 28 (37%) | |
| Sp-like | 25 (66%) | 47 (63%) | 0.832 |
| EMSY Amplification | | | |
| Amplification | 0 (0%) | 9 (15%) | |
| No amplification | 23 (100%) | 51 (85%) | 0.057 |

ER+ Tumors and BRCA2-Like Profile and EMSY Amplification

Table 3 gives an overview of BRD characteristics in ER+ tumors. Many ER+ tumors show a BRCA2-like pattern or an amplification of the BRCA2 inactivating protein EMSY. Interestingly, a BRCA2-like pattern and EMSY amplification occur only in one tumor sample together (Table 3).

TABLE 3
Overview of HRD characteristics in ER+ tumors*

| Sample Number | BRCA2 like | EMSY amplification |
|---|---|---|
| 2055 | − | − |
| 2105 | − | − |
| 2099 | + | + |
| 2013 | + | |
| 2016 | + | |
| 2017 | + | |
| 2032 | + | |
| 2044 | + | |
| 2114 | + | |
| 2138 | + | |
| 2147 | + | |
| 100 | + | − |
| 158 | + | − |
| 2062 | + | − |
| 2065 | + | − |
| 2071 | + | − |
| 2073 | + | − |
| 2075 | + | − |
| 2077 | + | − |
| 2085 | + | − |
| 2098 | + | − |
| 2117 | + | − |
| 2122 | + | − |
| 2128 | + | − |
| 2143 | + | − |
| 2144 | + | − |
| 2151 | + | − |
| 2153 | + | − |
| 2081 | + | − |
| 2100 | + | − |
| 2086 | − | + |
| 2087 | − | + |
| 110 | − | + |
| 112 | − | + |
| 2038 | − | + |
| 2058 | − | + |
| 2084 | − | + |
| 2120 | − | + |
| 2023 | − | . |

*Only samples with at least one characteristic are shown

Table 4 gives an overview of HRD characteristics related to clinical pathological factors. It was determined whether BRCA2 and EMSY were related to PR positivity, T-stage, and N-stage. For a BRCA2 pattern, no association was observed for PR positivity, T-stage and N-stage.

TABLE 4
Association between BRCA2 pattern and EMSY amplification and clinical
pathological variables in ER+ tumor samples.

| | BRCA2 like pattern | | | EMSY | | |
|---|---|---|---|---|---|---|
| | BRCA2-like | Sporadic-like | p-value | Amplification | No amplification | p-value |
| PRpos | 15/27 (56%) | 36/47 (77%) | 0.072 | 7/9 (78) | 34/51 (68) | 0.71 |
| T-stage | | | | | | |
| 1 | 2/28 (7%) | 8/48 (17%) | | 0 (0%) | 8/51 (16%) | |
| 2 | 18/28 (64%) | 26/48 (54%) | | 5/9 (56%) | 28/51 (55%) | |
| 3 | 7/28 (25%) | 13/48 (27%) | | 4/9 (44%) | 14/51 (28%) | |
| 4 | 1/28 (4%) | 1/48 (2%) | | 0 | 1/51 (2%) | |
| N-stage | | | | | | |
| Pos | 19/28 (68%) | 41/48 (83%) | 0.086 | 7/9 (78%) | 41/51 (80%) | 1 |

Discussion

Classical chemotherapeutic agents that cause DNA double-strand breaks (DSBs) are thought to be particularly effective in tumors with HRD (Kennedy, R. D., Quinn, J. E., Mullan, P. B., Johnston, P. G. and Harkin, D. P. The role of BRCA1 in the cellular response to chemotherapy, J Natl Cancer Inst, 96: 1659-1668, 2004; Fedier, A., Steiner, R. A., Schwarz, V. A., Lenherr, L., Haller, U. and Fink, D. The effect of loss of Brca1 on the sensitivity to anticancer agents in p53-deficient cells, Int J Oncol, 22: 1169-1173, 2003; Helleday, T., Petermann, E., Lundin, C., Hodgson, B. and Sharma, R. A. DNA repair pathways as targets for cancer therapy, Nat Rev Cancer, 8: 193-204, 2008; Moynahan, M. E., Cui, T. Y. and Jasin, M. Homology-directed dna repair, mitomycin-c resistance, and chromosome stability is restored with correction of a Brca1 mutation, Cancer Res, 61: 4842-4850, 2001; and Powell, S. N. and Kachnic, L. A. Therapeutic exploitation of tumor cell defects in homologous recombination, Anticancer Agents Med Chem, 8: 448-460, 2008) and the novel class of PARP inhibiting drugs has been shown to have marked antitumor activity with very little toxicity (Bryant, H. E., Schultz, N., Thomas, H. D., et al Specific killing of BRCA2-deficient tumours with inhibitors of poly(ADP-ribose) polymerase, Nature, 434: 913-917, 2005; and Farmer, H., McCabe, N., Lord, C. J., et al Targeting the DNA repair defect in BRCA mutant cells as a therapeutic strategy, Nature, 434: 917-921, 2005). Unfortunately, a demonstration of HRD in clinical tumor samples is problematic. One reported assay measures DSB repair pathways, but requires short-term cultures of primary breast cancer cells (Keimling, M., Kaur, J., Bagadi, S. A., Kreienberg, R., Wiesmuller, L. and Ralhan, R. A sensitive test for the detection of specific DSB repair defects in primary cells from breast cancer specimens, Int J Cancer, 123: 730-736, 2008). Immunohistochemical methods have been proposed as well, aiming to detect CHK1 and RAD51 localization in the cytoplasm and/or the nucleus (Honrado, E., Osorio, A., Palacios, J., et al Immunohistochemical expression of DNA repair proteins in familial breast cancer differentiate BRCA2-associated tumors, J Clin Oncol, 23: 7503-7511, 2005), but reliable immunohistochemical staining results can be difficult to obtain. Others have used methylation assays for BRCA1 (Esteller, M., Silva, J. M., Dominguez, G., et al Promoter hypermethylation and BRCA1 inactivation in sporadic breast and ovarian tumors, J Natl Cancer Inst, 92: 564-569, 2000; and Catteau, A., Harris, W. H., Xu, C. F. and Solomon, E. Methylation of the BRCA1 promoter region in sporadic breast and ovarian cancer: correlation with disease characteristics, Oncogene, 18: 1957-1965, 1999), FancC and FancD and have studied EMSY amplification (Rodriguez, C., Hughes-Davies, L., Valles, H., et al Amplification of the BRCA2 pathway gene EMSY in sporadic breast cancer is related to negative outcome, Clin Cancer Res, 10: 5785-5791, 2004), e.g. by an in situ hybridization assay (Turner, N., Tutt, A. and Ashworth, A. Hallmarks of ‘BRCAness’ in sporadic cancers, Nat Rev Cancer, 4: 814-819, 2004). The sensitivity and specificity of these approaches is unknown and a possible association of these features with neoadjuvant treatment response has not been reported.

High-dose alkylating chemotherapy in the treatment of patients with breast cancer, with either a high risk of relapse (Rodenhuis, S., Bontenbal, M., Beex, L. V., et al High-dose chemotherapy with hematopoietic stem-cell rescue for high-risk breast cancer, N Engl J Med, 349: 7-16, 2003) or with distant metastases (Schrama, J. G., Baars, J. W., Holtkamp, M. J., Schornagel, J. H., Beijnen, J. H. and Rodenhuis, S. Phase II study of a multi-course high-dose chemotherapy regimen incorporating cyclophosphamide, thiotepa, and carboplatin in stage 1V breast cancer, Bone Marrow Transplant, 28: 173-180, 2001), has been previously reported. In both studies, a modest survival advantage for patients who had received this intensive treatment was observed, a result which has also been documented in meta-analyses of the randomized studies (Berry, D. A., Ueno, N. T., Johnson, M. M., et al High-dose chemotherapy with autologous stem-cell support versus standard-dose chemotherapy: meta-analysis of individual patient data from 6 randomized metastatic breast cancer trials, Proc. San Antonio Breast Cancer Symp, Abstract 6113:2008). These observations are consistent with the existence of a putative subgroup of breast cancers that is highly responsive to alkylating drugs (Rodenhuis, S. The status of high-dose chemotherapy in breast cancer, Oncologist, 5: 369-375, 2000; and Rodenhuis, S. High-dose chemotherapy in breast cancer—interpretation of the randomized trials, Anticancer Drugs, 12: 85-88, 2001).

In the series of patients described in this Example, the frequency of certain features associated with HRD in untreated breast cancers was studied. BRCA2 inactivation, shown by a BRCA2 like aCGH profile and EMSY amplification, was specifically observed in ER+ tumors.

Features of BRCA2 Inactivation

Of the ER+ and TN tumors combined, roughly one-third had a BRCA2-like profile, while EMSY amplification was exclusively found in the ER+ tumors. In a series of 183 breast tumors from BRCA2 mutation carriers and from sporadic breast tumors, BRCA2 methylation has been assessed, but methylation was not found in any of the samples (Joosse, S. A., Brandwijk, K. I. M., Devilee, P., et al Prediction of BRCA1- and BRCA2-association in hereditary breast carcinomas with array-CGH, Breast Cancer Res Treat. 2010 Jul. 8. PubMed PMID: 20614180). In the literature, BRCA2 promotor methylation has been sporadically observed in ovarian cancer (Hilton, J. L., Geisler, J. P., Rathe, J. A., Hattermann-Zogg, M. A., DeYoung, B. and Buller, R. E. Inactivation of BRCA1 and BRCA2 in ovarian cancer, J Natl Cancer Inst, 94: 1396-1406, 2002), but not in breast cancer. An alternative mechanism for BRCA2 inactivation involves amplification of the EMSY gene. Interestingly, the present study did not identify overlap between tumors showing a BRCA2-like profile and EMSY amplification, except for one case (Table 3). This observation points at two different routes or levels of BRCA2 inactivation. In tumors with EMSY amplification, usually a lower degree of chromosomal gains and losses is observed than in the BRCA2-like tumors. Moreover, in a different series of 52 sporadic tumors from which aCGH data are available at the Netherlands Cancer Institute, 7 ER+ tumors with a gain at the EMSY locus were detected, and none of these showed a BRCA2 like profile. This supports the finding that EMSY and the BRCA2 like profile only rarely occur together and that EMSY amplification is not associated with the same degree of chromosomal instability as BRCA2 mutation. In vitro assays have shown that the EMSY protein can bind BRCA2 protein and inactivate its function (Raouf, A., Brown, L., Vrcelj, N., et al Genomic instability of human mammary epithelial cells overexpressing a truncated form of EMSY, J Natl Cancer Inst, 97: 1302-1306, 2005). An increase in chromosomal instability was observed after EMSY overexpression. However, it is not clear if EMSY amplification affects the role of BRCA2 in the maintenance of genomic instability in vivo, which may depend on the levels of both proteins and their cellular localization.

### CONCLUSION

In ER+ tumors, an aCGH “BRCA2-like” pattern and the amplification of the BRCA2 inhibiting gene EMSY were frequently observed (37% and 15% respectively). In addition, EMSY amplification and a “BRCA2-like” pattern rarely occurred together, raising doubts about the assumption that EMSY amplification inactivates BRCA2 and causes.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

1. A method of identifying a tumor, comprising:
obtaining a test sample from a patient;
detecting the copy numbers of DNA in the test sample in at least one of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28; and
comparing the copy numbers in the test sample to corresponding copy numbers in a reference sample;
wherein a variation in the copy numbers in the test sample in at least one of the genomic loci selected from 6p25.3-11.1, 6q12-13, 10q22.3-26.13, 13q12.2-21.1, 13q31.3-33.1 and 14q23.2-32.33 identifies the test sample as from a BRCA2-associated tumor; and
wherein a variation in the copy numbers in the test sample in at least one of the genomic loci selected from 2q36.3-37.1, 4p13-12, 16p12.3-11.2, 16q12.1-21, 17q11.1-12 and 17q21.2-21.31 identifies the test sample as from a sporadic tumor.

2. The method of claim 1, wherein an increase in the copy numbers in the test sample in at least one, or a plurality, of genomic loci selected from 6p25.3-11.1, 6q12-13 and 13q31.3-33.1 identifies the test sample as from a BRCA2-associated tumor.

3. The method of claim 1, wherein a decrease in the copy numbers in the test sample in at least one, or a plurality, of genomic loci selected from 10q22.3-26.13, 13q12.2-21.1 and 14q23.2-32.33 identifies the test sample as from a BRCA2-associated tumor.

4. The method of claim 1, wherein an increase in the copy numbers in the test sample in the genomic locus 16p12.3-11.2 identifies the test sample as from a sporadic tumor.

5. The method of claim 1, wherein a decrease in the copy numbers in the test sample in at least one, or a plurality, of genomic loci selected from 2q36.3-37.1, 4p13-12, 16q12.1-21, 17q11.1-12 and 17q21.2-21.31 identifies the test sample as from a sporadic tumor.

6. (canceled)

7. The method of claim 1, wherein the detecting is performed by array comparative genomic hybridization using an array.

8-11. (canceled)

12. An array comprising a plurality of probes immobilized on a substrate, wherein the probes hybridize to DNA from at least one genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28.

13. The array of claim 12, wherein the probes hybridize to DNA from the genomic loci 6p25.3-11.16q12-13 and 13q31.3-33.1.

14. (canceled)

15. The array of claim 12, wherein the probes hybridize to DNA from the genomic loci 10q22.3-26.13, 13q12.2-21.1 and 14q23.2-32.33.

16. (canceled)

17. The array of claim 12, wherein the probes hybridize to DNA from the genomic locus 16p12.3-11.2.

18. (canceled)

19. The array of claim 12, wherein the probes hybridize to DNA from the genomic loci 2q36.3-37.1, 4p13-12, 16q12.1-21, 17q11.1-12 and 17q21.2-21.31.

20. (canceled)

21. The array of claim 12 wherein the probes at least hybridize to:
DNA from the genomic loci 6p25.3-11.1, 6q12-13 and 13q31.3-33.1;
DNA from the genomic loci 10q22.3-26.13, 13q12.2-21.1 and 14q23.2-32.33;
DNA from the genomic locus 16p12.3-11.2; and/or
DNA from the genomic loci 2q36.3-37.1, 4p13-12, 16q12.1-21, 17q11.1-12 and 17q21.2-21.31.

22-23. (canceled)

24. The array of claim 12, wherein the probes are derived from at least 100 of the BAC clones of FIG. 2.

25. The array of claim 12, wherein the probes are derived from all 704 of the BAC clones of FIG. 2.

26. A BRCA2 classifier comprising a plurality of probes, wherein the probes hybridize to DNA from at least one genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28.

27. The classifier of claim 26, wherein the probes hybridize to DNA from the genomic loci 6p25.3-11.1, 6q12-13 and 13q31.3-33.1.

28. The classifier of claim 26, wherein the probes hybridize to DNA from the genomic loci 10q22.3-26.13, 13q12.2-21.1 and 14q23.2-32.33.

29. The classifier of claim 26, wherein the probes hybridize to DNA from the genomic locus 16p12.3-11.2.

30. The classifier of claim 26, wherein the probes hybridize to DNA from the genomic loci 2q36.3-37.1, 4p13-12, 16q12.1-21, 17q11.1-12 and 17q21.2-21.31.

31-35. (canceled)
